(19) United States
(12) Patent Application Publication
(10) Pub. No.: US 2022/0383428 A1
(43) Pub. Date: Dec. 1, 2022

(54) SYSTEMS AND METHODS FOR USE IN PLANTING SEEDS IN GROWING SPACES

(71) Applicant: CLIMATE LLC, San Francisco, CA (US)

(72) Inventors: Jigyasa BHAGAT, South San Francisco, CA (US); James DELANEY, Tiburon, CA (US); Thomas EICKHOFF, Dardenne Prairie, MO (US); Gardar JOHANNESSON, Oakland, CA (US); Brian LUTZ, Saint Charles, MO (US); Nick OCHS, Ellisville, MO (US); Harish SANGIREDDY, Mill Creek, WA (US); Yiwen XIANG, Seattle, WA (US)

(21) Appl. No.: 17/824,845

(22) Filed: May 25, 2022

Related U.S. Application Data
(60) Provisional application No. 63/195,552, filed on Jun. 1, 2021.

(51) Int. Cl. G06Q 50/02; G06Q 10/06; G06N 7/00

(52) U.S. Cl. CPC G06Q 50/02; G06Q 10/06315; G06N 7/005

(57) ABSTRACT

Systems and methods for use in identifying a set of candidate seeds for a target field based on a prediction model are provided. One example method includes accessing, by a computing device, data from a data server, the data including data representative of seeds harvested from at least one of a research growing space, a development growing space, and a field growing space; generating a yield delta prediction model, based on at least a portion of the accessed data; for each of a plurality of candidate seeds, automatically generating a probability of a yield delta for the candidate seed, relative to a target seed, exceeding a performance threshold, based on the generated model; identifying, by the computing device, a set of the candidate seeds, based on the probability of the respective candidate seed satisfying a defined threshold; and outputting, by the computing device, the identified set of seeds to a user.

### CROSS-REFERENCE TO RELATED APPLICATIONS

This application claims the benefit of, and priority to, U.S. Provisional Application No. 63/195,552, filed Jun. 1, 2021, the entire contents of all of which are hereby incorporated by reference as if fully set forth herein. The applicant hereby rescinds any disclaimer of claim scope in the parent applications or the prosecution history thereof and advises the USPTO that the claims in this application may be broader than any claim in the parent applications.

### FIELD

The present disclosure generally relates to systems and methods for use in planting seeds in growing spaces and harvesting crops associated with the seeds, and in particular, to systems and methods associated with modeling yield performance of the seeds in connection with planting the seeds in the growing spaces, whereby, for example, seeds are selected for planting in split planting growing spaces based on model yield performance.

### BACKGROUND

This section provides background information related to the present disclosure which is not necessarily prior art.

It is known for seeds to be grown in fields for commercial purposes, whereby the resulting plants, or parts thereof, are sold by the growers for business purposes and/or profit. For example, corn may be grown by a farmer in a field owned, leased or managed by the farmer, and the corn grown and harvested from the field is then sold (e.g., for consumption by livestock, etc.). Consequently, farmers and other growers often seek to plant particular seeds, which are specific to needs/goals of the farmers (e.g., corn versus soybeans, etc.), climate conditions (e.g., drought tolerance, etc.), disease resistance, and also, based on performance of the seeds in order to maximize the yield of the planting. Farmers may rely on past performance of seeds in their fields or others' fields, or on recommendations based on the conditions of their fields, by seed providers, in selecting seeds for planting.

### SUMMARY

This section provides a general summary of the disclosure, and is not a comprehensive disclosure of its full scope or all of its features.

Example embodiments of the present disclosure generally relate to computer-implemented methods for use in identifying sets of candidate seeds for target fields based on prediction models. In one example embodiment, such a method for identifying candidate seeds generally includes accessing, by a computing device, data from a data server, where the data includes data representative of seeds harvested from at least one of a research growing space, a development growing space, and a field growing space; generating a yield delta prediction model, based on at least a portion of the accessed data; for each of a plurality of candidate seeds, automatically generating a probability of a yield delta for the candidate seed, relative to a target seed, exceeding a performance threshold, based on the generated model; identifying, by the computing device, a set of the candidate seeds, based on the probability of the respective candidate seed satisfying a defined threshold; and outputting, by the computing device, the identified set of seeds to a user.

Example embodiments of the present disclosure generally relate to systems for use in identifying sets of candidate seeds for target fields based on prediction models. In one example embodiment, such a system for use in identifying candidate seeds generally includes at least one data server including data representative of seeds harvested from at least one of a research growing space, a development growing space, and a field growing space; and at least one computing device in communication with the at least one data server. The at least one computing device is configured to generate a yield delta prediction model based on at least a portion of the data in the at least one data server; for each of a plurality of candidate seeds, automatically generate a probability of a yield delta for the candidate seed, relative to a target seed, exceeding a performance threshold, based on the generated model; identify a set of the candidate seeds based on the probability of the respective candidate seed satisfying a defined threshold; and output the identified set of seeds to a user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example system for accessing data related to different growing spaces and modeling predicted relative performance of seeds in ones of the growing spaces, for use in recommending seeds to one or more grower(s) for target fields;

FIG. 2 illustrates a schematic diagram of an example model that may be implemented in the system of FIG. 1 for determining a yield delta between two seeds, based on yield advantage of the relative seeds;

FIG. 3 illustrates another schematic diagram of an example model that may be implemented in the system of FIG. 1 for determining a yield delta between two seeds, based on BLUPs representative of certain data;

FIG. 4 illustrates example locations of growing spaces in an example region, where the region is divided based on bands of relative maturity that may be used to filter data implemented in the system of FIG. 1;

FIGS. 5A-5C illustrate example filtering of data relied on in building an example model, by the system of FIG. 1, in connection with the schematic diagram of the example model of FIG. 3;

FIG. 6 illustrates yet another schematic diagram of an example model for determining a yield delta between two seeds, based on latitude and longitude associated with certain data;

FIGS. 7A-7C illustrate example data and graphics associated with the data, which are indicative of implementation of a Bayesian framework, by the system of FIG. 1, based on the example model illustrated in FIG. 3;

FIG. 8 illustrates an example method of modeling yield performance to recommend seeds to growers, that may be used in the system of FIG. 1;

FIGS. 9A-9B illustrates example logical organization of sets of instructions in main memory when an example mobile application is loaded for execution;

FIG. 10 illustrates a programmed process by which the system of FIG. 1 generates one or more preconfigured agronomic model(s) using agronomic data provided by one or more data source(s);

FIG. 11 is a block diagram that illustrates a computer system upon which embodiments of the system of FIG. 1 may be implemented;

FIG. 12 depicts an example embodiment of a timeline view for data entry; and

FIG. 13 depicts an example embodiment of a spreadsheet view for data entry.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Seeds planted in fields (broadly, growing spaces) are selected by growers (broadly, users) based at least in part on the potential or expected yield of the seeds in the fields, and sometimes, the particular fields and/or parts of the fields. In connection therewith, growers may select different seeds to plant in the same fields, whereby direct comparison of the different seeds is available and the growers are able to designate one of the seeds as the better performer (e.g., as to yield, etc.). The seed comparison and prediction, in this manner, is limited due to various factors, including, for example, available fields, soil and weather conditions throughout the growing season, etc. The prediction of which seed(s) will perform better is further limited to seeds participating in split planting, for which sufficient data representative thereof is available. This later constraint often limits the inclusion of newly developed seeds and/or recently introduced seeds for consideration.

Uniquely, the systems and methods herein provide for prediction of relative seed performance, whereby recommendations as to which seeds should be planted can be generated. In particular, data associated with different sources, including, for example, split planting data (e.g., whereby environmental confounders are balanced, or close to balanced, among the seeds, etc.) is used to train a model (e.g., consistent with a Bayesian framework, etc.), which may then be used to predict performance differences among different seeds (e.g., yield deltas, etc.), for a target field. The prediction of performance, as defined by the model, provides a relative probability of the predicted yield deltas, for each candidate seed relative to a target seed. The probabilities may be employed, in combination with a defined threshold, to identify a set of candidate seeds to recommend to be planted with the target seed, based on a predicted outperformance of the candidate seeds over the target seed. In this manner, then, growers are permitted to witness, at or prior to harvest, the relative performance under the grower's own control, on or in the target field(s), whereby relative performance may result in convincing evidence to the grower for future purchases of seeds, as recommended.

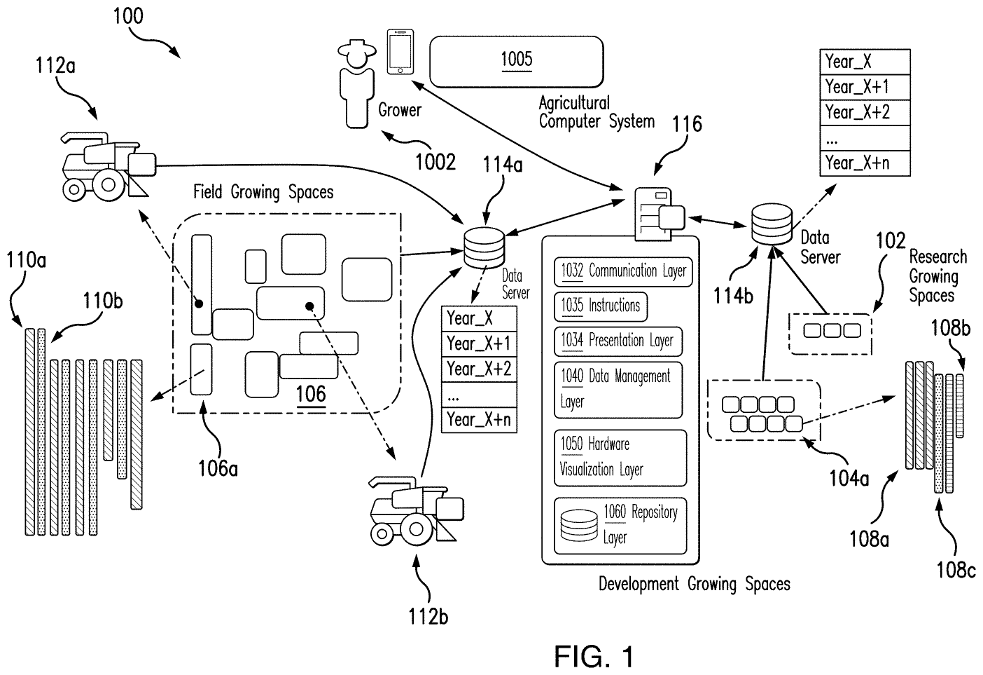

FIG. 1 illustrates an example system 100 in which one or more aspect(s) of the present disclosure may be implemented. Although the system 100 is presented in one arrangement, other embodiments may include the parts of the system 100 (or other parts) arranged otherwise depending on, for example, relationships between users, farm equipment and fields, data flows, types of plants included in the relative fields, types and/or locations of fields, planting and/or harvest activities, privacy and/or data requirements, etc.

As shown, the system 100 generally includes various growing spaces (e.g., greenhouses, shade houses, nurseries, plots, fields, etc.), which (without limitation) are designated into three different types: research growing spaces 102, development growing spaces 104, and field growing spaces 106. The research growing spaces 102 are generally owned, managed and/or operated by one or more seed development entities, whereby different seeds are bred and then planted and grown in the research growing spaces 102. The number and/or type of seeds in the research growing spaces 102 will also vary depending on the type(s) of seed and/or the objectives of the research being conducted, etc. In connection therewith, the seeds are planted in specific fields and subjected to certain conditions (planned and/or unplanned) (e.g., irrigation, treatments, etc.), and also measurements, whereby data is gathered related to the seeds and growth of the seeds, etc. Similarly, the development growing spaces 104 are often owned, managed, and/or operated by one or more seed development entities, whereby different seeds, often seeds previously included in the research growing spaces 102, are planted and grown in the development growing spaces 104. Often, but not always, the development growing spaces 104 will include a higher population of particular seeds, but fewer varieties of different seeds. In this manner, the development growing spaces 104 provide for further experimentation for fewer seeds, fewer varieties of seeds, and/or different seeds, etc., as compared to the research growing spaces 102. Again, in connection therewith, the seeds are planted and subjected to certain conditions (planned and/or unplanned) (e.g., irrigation, treatments, etc.), and also measurements, whereby data is gathered related to the seeds and growth of the seeds in the development growing spaces 104, etc.

In the illustrated system 100, one of the development growing spaces, which is referenced 104a, is illustrated in detail at 108a-c. The growing space 104a includes six sets of rows 108a-c, of which three sets of rows (e.g., with each set including one row, two rows, eight rows, ten rows, more or fewer rows, etc.) are one variety of seed 108a, two sets of rows are a different variety of seed 108b, and one set of rows are of a third variety of seed 108c. The different seeds 108a-c in the different rows are each designated by different hatching in FIG. 1. Each of the different seeds 108a-c is also kept together in the same and/or adjacent set of rows, and is also planted at the same time, in this example. It should be appreciated that, despite this example, the number of rows/sets, types and/or varieties of seeds, along with the distribution of the same or different seeds, and the planting times of the seeds, may vary in other growing space examples.

As noted above, data (e.g., agronomic data, etc.) is gathered at or from the research growing spaces 102 and the development growing spaces 104. The data may be gathered manually, or automatically, for example, by farm equipment, etc. The data may include plant/seed identifiers, plant/seed types, planting dates, location data, field identifiers, soil conditions, plant performance (e.g., height, strength, yield, etc.) (e.g., at one or more regular or irregular interval(s), etc.), treatments, weather conditions, and other suitable data to identify the seed/plant and/or a performance of the seed/plant, etc.

With continued reference to FIG. 1, the field growing spaces 106 of the system 100 are generally commercial fields, for which seeds are purchased by a grower, grown in the fields, and the crops, resulting from the seeds in the fields, are harvested and commercialized. The field growing spaces 106 are often owned by farmers and/or grower entities in the business of growing, harvesting and selling crops. In connection therewith, the farmers/growers may alter conditions of the field growing spaces 106, as the seeds grow into plants (e.g., through treatments, irrigation, etc.), and then harvest the crops with a variety of different farm equipment (e.g., combines, pickers, etc.).

It should be appreciated that the seeds may be planted in the field growing spaces 106 in a number of different manners. In one example, a field growing space may be subjected to split planting, in which multiple different seeds are planted in the same growing space. In the illustrated system 100, for example, one of the field growing spaces, which is referenced 106a, is shown in some detail. As shown, the field growing space 106a includes nine sets of rows, which, in turn, include two different types of seeds 110a, 110b, as indicated by the different hatching. The seeds are distributed in the field growing space 106a, such that every other set of rows (e.g., where each set of rows includes five rows, eight rows, tens rows, more or fewer rows, etc.) includes one type of the seeds 110a, 110b. In this manner, the seeds 110a, 110b are planted “side-by-side” (broadly, split planting or in a split-planting configuration) and subject to substantially similar conditions (e.g., relative to different fields in the same region, etc.), whereby the data from the growing space 106a is generally indicative of relative performance of the two seeds 110a, 110b. It should be appreciated that, despite this example, the number of rows/sets, types and/or varieties of seeds, along with the distribution of the same or different seeds, and the planting times of the seeds, may vary in other field growing spaces, depending, for example, of the growing objectives of the growers, soil conditions, harvesting conditions (e.g., width of a combine, etc.), market demand, etc.

Like above, data is gathered and stored in connection with the plants in the field growing spaces 106. Often, the data will be gathered manually, or automatically by harvesting equipment employed in the field growing spaces 106, as described in more detail below. Similar to the above, the data may include plant/seed identifiers, plant/seed types, planting dates, location data, field identifiers, soil conditions, plant performance (e.g., height, strength, yield, etc.) (e.g., at one or more regular or irregular interval(s), etc.), treatments, weather conditions, and other suitable data to identify the seed/plant and/or a performance of the seed/plant, etc.

In addition to the growing spaces in FIG. 1, the system 100 also includes a number of harvesting devices 112a-b, multiple data servers 114a-b, and an agricultural computer system 116, each of which is coupled to (and is in communication with) one or more network(s). The network(s) is/are indicated generally by arrowed lines in FIG. 1, and may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

In this example embodiment, the harvesting devices include a harvesting device 112a and a harvesting device 112b, each disposed in the field growing spaces 106. Nonetheless, it should be also appreciated that a different number and/or type of harvesting devices, which may be distributed differently among the different growing spaces, may be included in other system embodiments. For instance, while not shown, one or more additional harvesting device(s) (similar to harvesting devices 112a-b) may be implemented in one or more of the research growing spaces 102 and/or in one or more of the development growing spaces 104.

The harvesting devices 112a-b may include, for example, combines, pickers, or other mechanisms for harvesting plants/crops from the growing spaces 106 in FIG. 1. The harvesting devices 112a-b may be automated, or reliant, at least in part, on a human operator, etc. The harvesting device 112a-b, in general, may be configured to remove a particular part of the plant grown from the planted seed (e.g., ear of corn, beans from soybeans, grain from wheat, etc.), which is referred to herein as harvesting, and may perform operations including picking, threshing, cutting, reaping, gathering, etc. In connection therewith, the harvesting devices 112a-b are configured to compile data specific to the plant(s) being harvested and to the operation of harvesting of the plant(s), etc. The data may include, without limitation, yield, weight, moisture content, volume, flow, or other suitable data, etc. Moreover, in this example, the harvesting devices 112a-b may be configured to track their locations at given times, as they move through the growing spaces 106, as expressed in latitude/longitude or otherwise, and to correlate the locations to other data gathered/compiled by the harvesting devices 112a-b (e.g., permitting the data to be correlated to a specific plant and/or seed based on planting data for the harvested growing space, etc.).

Each of the harvesting devices 112a-b is further configured to transmit the gathered data to one or both of the data servers 114a-b, depending on the particular growing space(s) for which the data relates. In the illustrated system 100, harvesting devices associated with the research growing spaces 102 and the development growing spaces 104 are configured to transmit gathered data to the data server 114b, while the harvesting devices 112a-b associated with the field growing spaces 106 are configured to transmit gathered data to the data server 114a. That said, a different number of data servers 114a-b may be included in other system embodiments, with the different data servers being specific to certain growing spaces, or not. In one example, data servers may be segregated by field region, rather than, or in addition to, segregation by type of growing spaces.

The data servers 114a-b, in turn, are configured to store the received data in one or more data structures. In general, in this example embodiment, the data servers 114a-b are configured to store data by year (e.g., Year_X, Year_X+1, etc.), which correspond to the different growing years (e.g., 2015, 2016, 2017, etc.). Then, for each year, the data structure will include the data for each of the growing spaces, seeds, harvested plant, etc. For example, for each field designation or identifier, the data structure may include an identifier for each seed planted in the field in the given year, for brands for seeds, for relative maturity, for types of insect protection traits, for seed treatment years, for side-by-side or S×S designations, for positions/distributions of seeds in fields, for location definitions of fields, for acreage of fields, for populations of seeds planted in fields, for average yields and harvest grain moisture (e.g., based on location and seed products, etc.), etc. The data may also include soil conditions, field elevations, precipitation amounts, irrigation amounts, or any other data indicative of the growing conditions for the seeds/plants in the field, etc. It should be appreciated that any available and/or desired data may be collected with regard to the plots, fields, etc., in the different growing spaces and/or the seeds planted therein.

The data included in the data structure(s) of the data servers 114a-b may be augmented with additional information about seeds from one or more other sources, including, for example, a category of the seeds (e.g., in a breeding pipeline provided to create new plants by crossing existing pools of parents, in a commercial pipeline provided to commercialize desired products and sell such products to consumers, etc.) (e.g., relative maturity, etc.), product name, source name, etc.

It should be appreciated that relative data for the different ones of the growing spaces 102-106 in the system 100 may vary, for example, based on the populations of seeds and/or types of seeds in the spaces, numbers of the spaces, etc. For example, the research growing spaces 102 and development growing spaces 104 may be limited based on investment by seed development entities, while the number of field growing spaces 106 is not so limited. In connection therewith, as an example, the research growing spaces 102 may include at least about 5 such growing spaces, at least about 10 such growing spaces, at least about 50 such growing spaces, at least about 100 such growing spaces, at least about 200 such growing spaces, at least about 350 such growing spaces, at least about 500 such growing spaces, at least about 1,000 such growing spaces, numbers therebetween, etc. The development growing spaces 104 may include at least about 100 such growing spaces, at least about 500 such growing spaces, at least about 1,000 such growing spaces, at least about 1,500 such growing spaces, at least about 2,000 such growing spaces, at least about 2,500 such growing spaces, at least about 3,000 such growing spaces, at least about 5,000 such growing spaces, numbers therebetween, etc. And, the field growing spaces 106 may include at least about 1,000 such growing spaces, at least about 5,000 such growing spaces, at least about 7,500 such growing spaces, at least about 10,000 such growing spaces, at least about 15,000 such growing spaces, at least about 20,000 such growing spaces, at least about 25,000 such growing spaces, at least about 30,000 such growing spaces, numbers therebetween, etc. What's more, a number of different growing spaces 106 (and/or growing spaces 102 and/or growing spaces 104) may be included in a similar or same region. Accordingly, a given region may include multiple ones of the growing spaces 102, 104, and/or 106, and/or may specifically include multiple growing spaces 106 that include split planting of two or more seeds (e.g., two or more varieties of seeds, etc.).

In connection therewith, it should be appreciated that the seeds planted in the different growing spaces may be in (or associated with) different categories (or statuses or availabilities or maturities, etc.), for example, within a commercial or breeding pipeline, etc. ranging from introduction to the pipeline (e.g., category A, etc.), to currently present in the pipeline (e.g., category B (e.g., recently introduced, etc.), category C (e.g., long-term present, etc.), etc.), and to being removed from the pipeline (e.g., category D, etc.). Limited data, if any, will be included in the data server 114a (from the field growing spaces 106) for brand new or newly introduced seed products, as most data relating to these seeds in the data server 114a is based on the research growing spaces 102 and development growing spaces 104. For other seed products in other categories of seed products (e.g., where the seed products are currently active within a pipeline or are being removed (or have been removed) from a pipeline or are more mature, etc.), for example, additional data from field growing spaces 106 may also be available, yet data is still present for these seed products from the research growing spaces 102 and development growing spaces 104, for prior years. That said, newly introduced seed products (or less mature seed products) may account for up to about 1%, up to about 2%, up to about 5%, up to about 10%, up to about 15%, more than about 15%, etc. of individual products in a seed supplier's catalog, with the remaining products being those ranging between such introduction and removal. Additionally, data in the data server 114a for the field growing spaces 106 for new seed products is often very limited or even nonexistent. As such, up to about 1%, up to about 2%, up to about 5%, up to about 10%, up to about 15%, more than about 15%, etc. of the data in the data server 114a for the field growing spaces 106 may relate to seed products that have been removed, for example, from a pipeline, etc. Data in the data server 114a for the development growing spaces 104 also includes no or very limited data for new seed products. For instance, up to about 0.1%, up to about 0.5%, up to about 1%, up to about 2%, up to about 3%, up to about 5%, more than about 5%, etc. of the data in the data server 114a from research growing spaces 102 may relate to newly introduced seed products (or less mature seed products). In general, for each of these growing spaces, a majority (e.g., at least about 50%, at least about 60%, at least about 70%, at least about 75%, at least about 80%, at least about 85%, etc.) of the data in the data server 114a may correspond to seed products that are in a category someplace between introduction into a given pipeline and removal therefrom.

Given the above, the agricultural computer system 116 is programmed, or configured, to access the data related to the different growing spaces 102-106 from the data servers 114a-b, and to predict a relative yield performance between multiple candidate seeds and a target seed for a target field.

In particular, at the outset, a user selects a target field for which a recommendation is requested, and also a target seed as the basis for the relative recommendation. The agricultural computer system 116 is programmed, or configured, to present one or more interface(s) to the user, or otherwise permit the user to provide an input indicative of the target field and/or the target seed. In turn, the agricultural computer system 116 is configured to receive the input and to access data from the data server(s) 114a-b (e.g., in general, or specific to a region, etc.), based at least in part on the inputs, or not. The agricultural computer system 116 is configured to then train a model, based on a training set of the accessed data. The data includes, among other things, an identification of the candidate seeds, the yield data for the seeds in specific growing spaces, the acreage of the growing spaces, etc., and then various distribution parameters. The model, in this example embodiment, is configured to define a relationship between the data, whereby a yield delta is determined based on relative yield advantages between the candidate seeds. In particular, the yield delta generally defines a relative predicted performance of the candidates seed, expressed as a probability, in this embodiment, whereby the probability is based on the yield advantages of the candidates seeds and, potentially, other parameters of the data (e.g., error, acreage, noise, location, grower insights, etc.). In this example embodiment, then, based on the model, the agricultural computer system 116 is programmed, or configured, to predict the relative performance of one or more candidate seed(s) relative of the target seed and/or target field, to apply one of more threshold(s) to the predicted relative performances, and then to output a listing of candidate seeds based on the relative performances and the one or more thresholds, etc. The user may include a farmer, an individual selling or otherwise marketing or promoting the candidate seeds for planting, or other use, etc.

It should be appreciated that a variety of different modeling techniques may be employed by the agricultural computer system 116 to generate the listing of candidate seeds. For example, seed performance may be predicted using mixed effect linear statistical models. Such models emphasize absolute yield prediction, rather than predicting relative performance, for instance, the yield deltas. Models for relative performance include, for example, the Bradley-Terry models which may be used to predict the probability of a winner in a two product comparison. Alternatively, Bayesian models may be formulated which better capture multiple sources of variation and provide more flexibility in prediction. That said, multiple examples of Bayesian models are presented below for illustration purposes only, as potential implementations for such modeling of the accessed data by the agricultural computer system 116.

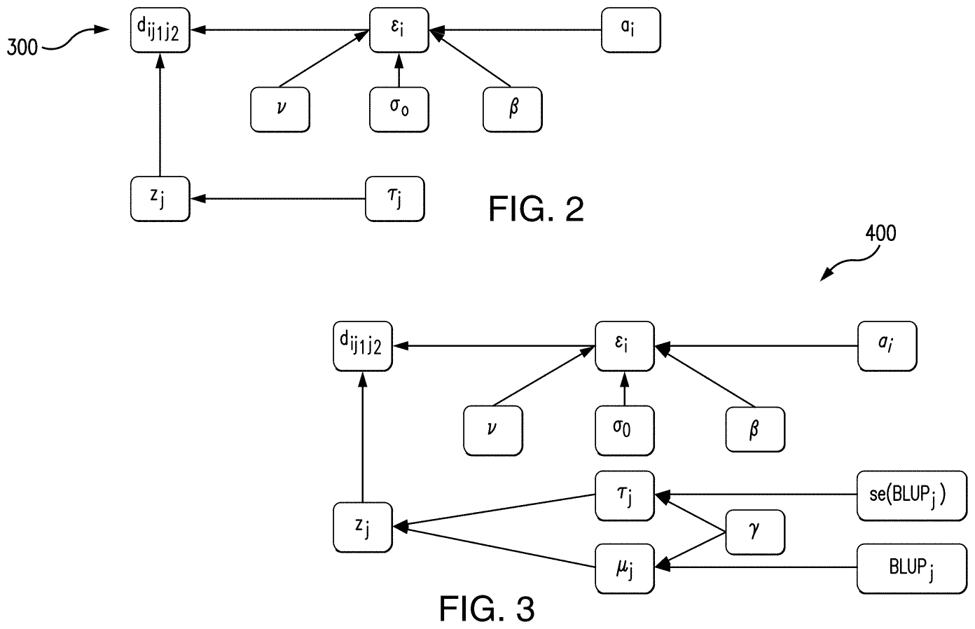

For example, with reference to FIG. 2, in one implementation, the agricultural computer system 116 is programmed, or configured, to train a model 300. As shown, the model 300 defines a predicted yield delta, d, for trial index i for two candidate seeds, which are designated j₁ and j₂. The yield delta, d, is expressed in terms of yield advantage for each of the two candidate seeds, zⱼ. The yield advantages of the candidate seeds, and all candidate seeds in the training data, is constrained to a normal distribution centered on zero in this embodiment, whereby yield advantages of certain candidate seeds will be positive and yield advantages of other candidates seeds will be negative. That said, the distribution of the yield advantages may be constrained otherwise in other implementations and/or models. To be clear, the candidate seeds may include any seed represented in the data from the growing spaces 102-106 in the system 100, for which data is included in the training set of data, and seeds are “candidates” to be recommended for having an improved relative performance as compared to a target seed.

The model 300 is provided in expression form in Equation (1) below, and the distribution of the yield advantage is expressed in Equation (2).

dᵢⱼ_{₁}ⱼ_{₂}=zⱼ_{₁}−zⱼ_{₂}+σᵢεᵢⱼ_{₁}ⱼ_{₂} (1)

zⱼ˜N(0,τⱼ) (2)

As indicated in Equation (1), the yield delta dᵢ is based on the yield advantage for the first candidate seed zⱼ_{₁}, the yield advantage of the second candidate seed zⱼ_{₂}, and then also a noise expression relative to the yield advantages, based on σᵢ and εᵢ (as defined below). The yield advantage zⱼ may be interpreted, for example, as the performance, or yield, of product i relative to a hypothetical average performing project in a particular region.

In this example, the yield advantage is based, at least in part, on the spread of the distribution around zero, which is defined by τⱼ. The spread may be a standard deviation and/or a variance permitted in the distribution of the yield advantage of the candidate seeds.

Further, the model 300 illustrates that the noise around of the yield delta as based on an overlapping acreage of the candidate seeds in a trial (e.g., each individual growing space, etc.), as designated aᵢ, and a combination of εᵢ, ν, σ₀, and β, where ν is the degrees of freedom of a distribution (e.g., t-distribution, etc.), σ₀ is the overall scaling of the error for the different growing spaces, and β represents (or affects) how that error decreases as acreage increases for a trial. These terms are combined as defined in Equations (3) and (4) below and incorporated into Equation (1) above.

σᵢ=σ₀aᵢ^{β} (3)

εᵢⱼ_{₁}ⱼ_{₂}˜t(v) (4)

Given the distribution constraints on the yield advantage for each candidate seed in Equation (1), the agricultural computer system 116 is programmed, or configured, to train the model 300 with a given training set of data from the growing spaces 102-106. In this example, the training data set generally includes data from field growing spaces 106 (which may, optionally, be filtered or not), thereby including split planting data indicative of direct relative performance of specific candidate seeds. In other examples, the training data set may be representative of more than the field growing spaces 106 (e.g., it may include data from the research growing spaces 102 and/or the development growing spaces 104, etc.). From the training, the terms explained above are determined, for numerous samples, through the Bayesian framework. As a result of the training, a data structure of values is generated by the agricultural computer system 116, which includes numerous different samples. Each of the samples, as explained in more detail below, will include values satisfying the above equations and the constraints applied thereto. The data structure of values for the samples, from the Bayesian framework, define for this implementation, the model of the yield deltas for the candidates seeds.

In another example implementation, the agricultural computer system 116 is programmed, or configured, to train a model 400, as indicated by the example schematic in FIG. 3. As shown, like above, the model 400 defines a predicted yield delta, d, for trial index i for two candidate seeds, which are designated j₁ and j₂. In this implementation, as shown, the yield deltas rely on best linear unbiased prediction (BLUPs). The BLUPs are included in model 400 as a manner of including data from the research growing spaces 102 and/or the development growing spaces 104, which is data that may be presented differently than data from the field growing spaces 106 (e.g., split planting data, etc.) and/or that may have different distributional properties relative to the data for the field growing spaces 106 based on conditions, constraints, limitations, or features of the research growing spaces 102 and/or the development growing spaces 104 (e.g., advantageous growing conditions for breeding purposes, etc.).

As shown, the model 400 includes the yield advantage, referenced zⱼ, consistent with the model 300 (and with Equations (1), (3), and (4)). In the model 400, however, the yield advantage is based on a normal distribution based on μⱼ and τⱼ, as indicated in Equation (5) below. The term τⱼ is associated with the spread of the distribution of the yield advantage for candidate seeds, while the term μⱼ is associated with the location of the distribution of the yield advantage.

zⱼ˜N(μⱼ,τⱼ) (5)

Further, as noted, the model 400 relies on BLUPs to represent the data from the data server 114a, which includes data from the research growing spaces 102 and the development growing spaces 104. The BLUPs are included in the model 400, as shown in FIG. 3, and further, as expressed in Equations (6) and (7) below.

μⱼ={BLUPⱼ×γ,when BLUPⱼ exists, or 0 otherwise (6)

τⱼ=(τ_{B}²+(se(BLUPⱼ)×γ) when BLUPⱼ exists, or τ_{N}² otherwise (7)

BLUPⱼ provides a summary of seed product j's yield from the growing spaces 102 and 104. More precisely, this is the best linear unbiased predictor for the seed product j from a random effects model, which is centered on zero, for the above data. A standard error for the BLUPⱼ is expressed as se(BLUPⱼ), and a scaling factor, γ, is included to, for example, account for different conditions, constraints, limitations, or features of the research growing spaces 102 and the development growing spaces 104, relative to the field growing spaces 106. More generally, to the different growing spaces 102-106, the performance of seeds in the research growing spaces 102 and the development growing spaces 104 may be optimal, or potentially, improved (e.g., given the limited number of growing spaces, the objectives of the research/development processes, etc.), over the field growing spaces 106. The factor γ may, among other things, scale the BLUPs, in the model 400, to limit the impact of various growing conditions, constraints, limitations, or features of the seeds grown in the research growing spaces 102 and the development growing spaces 104, and data related thereto from the data server 114a.

It should be understood that the BLUPs are generated, as is known in the art, for the yield data of the research growing spaces 102 and the development growing spaces 104, and included via Equations (6) and (7) into Equation (5). The BLUPs are computed for each seed product using, for example, research development data, etc. The BLUPs are simple random mixed models that utilize the field, crop year season and seeding rates. The BLUPs are generated in advance of training the modeling shown in FIG. 3, whereby model 400 defines a two stage process to define yield deltas of the different candidates seeds.

As above, in this implementation, given the distribution constraints on the yield advantage for each candidate seed in Equation (1), the agricultural computer system 116 is configured to train the model 400 with a given training set of data from the growing spaces (i.e., data from the field growing spaces 106 (e.g., split planting data, etc.) and BLUPs representative of the data from the research growing spaces 102 and the development growing spaces 104.

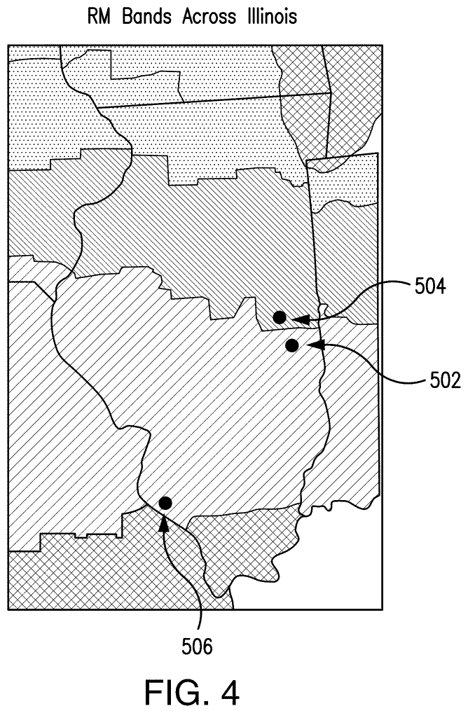

In connection therewith, as above, it should be appreciated that the training data set, while including data representative of the different growing spaces 102-106, may be filtered prior to training the model 400. Various manners of filtering the training data, or the data in general, in association with modeling the yield deltas may be applied. FIG. 4 illustrates a first technique for filtering data accessed from the data servers 114a-b based on relative maturity (RM). As shown in FIG. 4, a region including Illinois (representative of including the growing spaces 102-106) is separated by bands (indicated by coloring/hatching) associated with RM. The RM is indicative of the class of seed products that will likely reach their yield potential within the length of the growing season that is typical for a region, which provides a basis to link performance of different seeds to one another, etc. Consequently, in one example, the agricultural computer system 116 may be configured to build, or define, the training data set by filtering the accessed data, for the given region, based on the bands illustrated in FIG. 4.

As shown in FIG. 4, three different fields are located in the Illinois region, at 502, 504 and 506. The fields 502 and 506 are in the same RM band, while the field 504 is in a different RM band. However, the field 502 is only about twenty miles away from the field 504, and the field 502 is about one hundred thirty miles from field 506. It should be apparent that, when filtering based on RM bands, the data included in the training data set may be different for certain fields that are close together (e.g., fields 502 and 504, etc.) as compared to other fields in the same RM bands (e.g., fields 502 and 506, etc.), which may result in variable recommendations. While filtering the data based on RM bands, to define the training data set, may be suitable for some embodiments (e.g., the RM band model may be used for recommendations throughout the region of the RM band, etc.), it may be unsuitable in other embodiments.

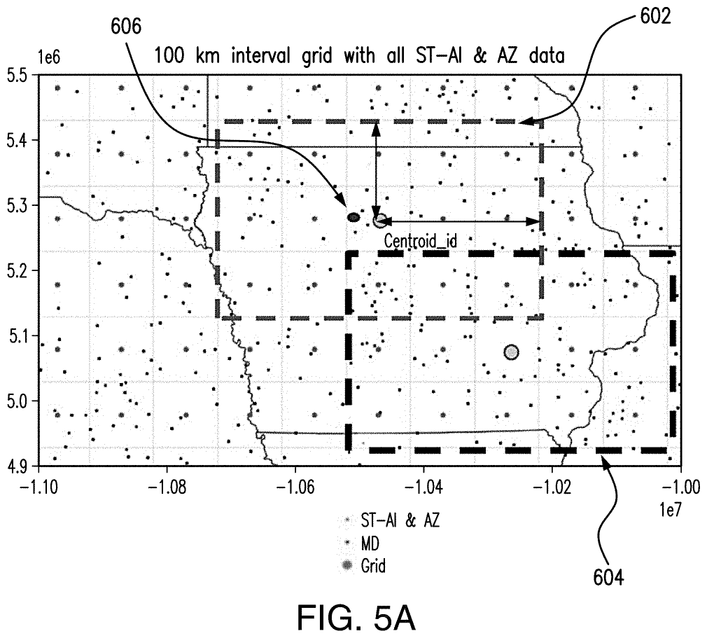

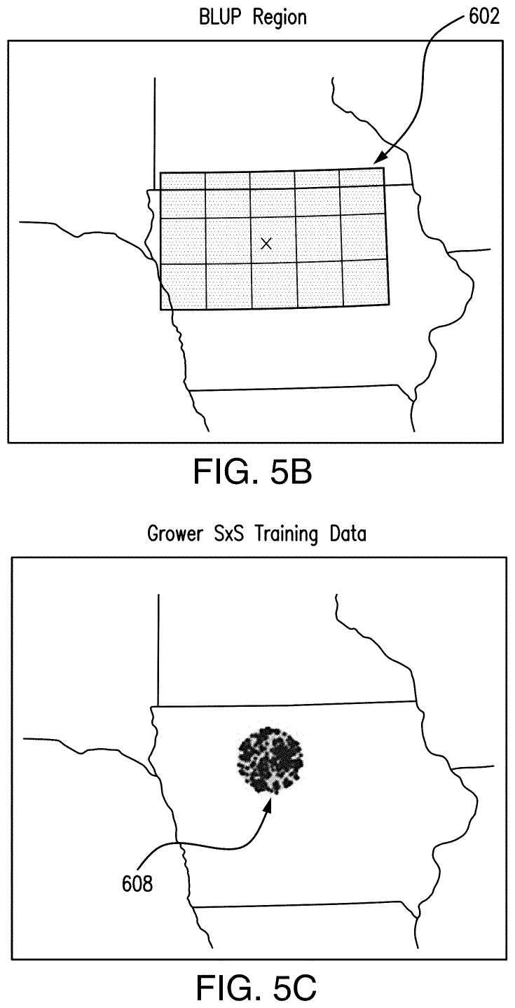

FIGS. 5A-5C illustrate an alternate filtering of the accessed data to form the training data set. In this example, the agricultural computer system 116 is programmed, or configured, to define regions associated with the BLUPs, where each region includes a length and a width for a rectangular region, and other measures for other shaped regions, and a center, etc. The region(s) may be defined by any suitable size, and may overlap, or not, in any suitable interval, and further may be of the same size or different sizes (e.g., depending on the data within the region, etc.), etc. As shown in FIG. 5A, for example, the two regions 602, 604 overlap by almost twenty-five percent. Each of these two regions 602, 604 may be upwards of about 30,000 square miles, for example. That said, other percentages of overlap may be defined by the regions 602, 604 in other examples, etc. Also, it should be appreciated that while the regions 602, 604 may be of any suitable size, the region will often be defined at a size to provide suitable or sufficient data from the research growing spaces 102 and development growing spaces 104 to train the model 400. In this example, the regions are used to filter the data to define the BLUPs used in Equations (6) and (7). For a target field 606 (in region 602), the agricultural computer system 116 is configured to determine a center of the defined region closest to the target field 606, whereby the region 602 is identified as the BLUP region, as shown in FIG. 5B. The agricultural computer system 116 is configured to then use the BLUPs, or underlying data, to build BLUPs from the identified region 602.

Further, as shown in FIG. 5C, the data from the field growing spaces 106 (e.g., the split planting data, etc.) is filtered based on a location of the target field, whereby the agricultural computer system 116 is configured to filter data, based on, in this example, a relative distance from the target field, such as, for example, ten kilometers, twenty kilometers, thirty kilometers, forty kilometers, fifty kilometers, sixty kilometers, seventy kilometers, eighty kilometers, ninety kilometers, one hundred kilometers, etc., whereby the region of data for the field growing spaces 106 is generally a circle centered on the target field, and referenced 608 in FIG. 5C, and that is increased in 10 kilometer increments until the filtered data has an adequate number of records, for example, 500, more than 500, fewer than 500, etc. That said, in other examples, the agricultural computer system 116 may be configured to otherwise define a filter for the data for field growing spaces 106, based on different shaped regions, criteria, etc. (e.g., other than circular, etc.).

In this example embodiment, the filtering illustrated in FIGS. 5A-5C is employed with the example model 400. While the above is presented in connection with filtering accessed data, it should be appreciated that the data may be accessed consistent with the above constraints, rather than accessed in total and then filtered by the agricultural computer system 116 in other example embodiments.

From the training data set (e.g., as defined by FIGS. 5B and 5C, etc.), the terms explained above in the model 400 are determined, for numerous samples, through the Bayesian framework. As a result of the training, a data structure of values is generated, as the model, by the agricultural computer system 116, which includes numerous different samples. Each of the samples includes values satisfying the above equations and the constraints applied thereto.

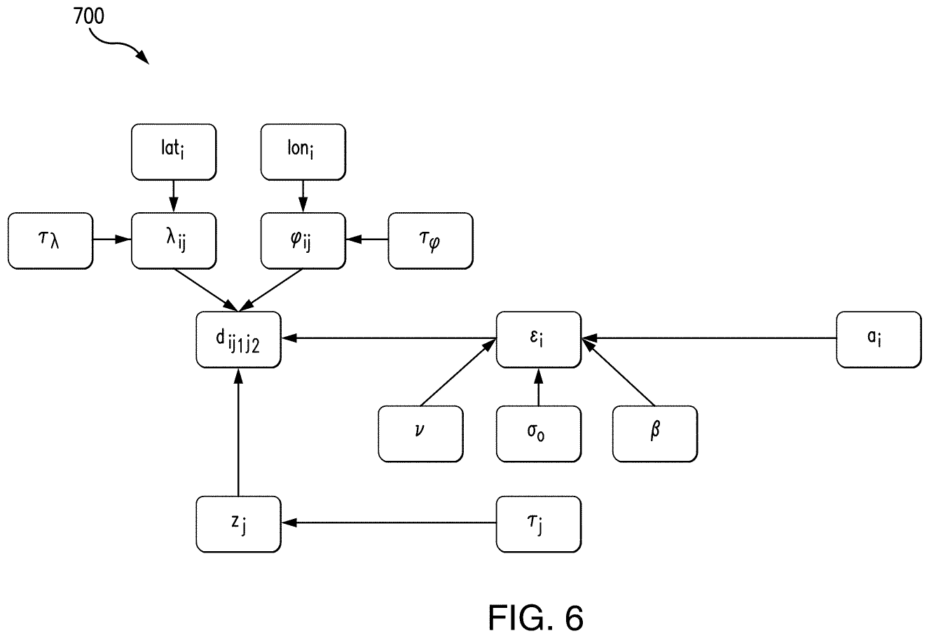

In still another example implementation, the agricultural computer system 116 is programmed, or configured, to train a model 700 indicated by the example schematic in FIG. 6. As shown, like above, the model 700 defines a predicted yield delta, d, for trial index i for two candidate seeds, which are designated j₁ and j₂. In this implementation, the model 700 is generally consistent with the model 300 (and with Equations (1), (3), and (4)), and further includes adjusting for the location of the target field. More generally, in connection with FIGS. 4-5C, the agricultural computer system 116 is configured to filter the accessed data to a specific RM band, or a specific region (in general, or per data type) (or to originally access the data accordingly). The resulting model, then, is specific to the RM band or region, and may be retrained for different target fields in different locations, thereby altering, potentially, the training data set.

The model 700 permits additional data to be included in the training data set, in that the model 700 adjusts the yield delta based on location, i.e., the model 700 localizes the prediction. As shown, the model 700 relies on a latitude and a longitude of the instance i. The model 700 includes λᵢⱼ and φᵢⱼ which defines normal distributions (e.g., centered at zero, etc.) and τ_{λ}, and τ_{φ} which defines the spread of the respective distributions. As such, when combined with Equation (1) for example, the model 700 may be expressed as Equation (8) below.

dᵢⱼ_{₁}ⱼ_{₂}=zⱼ_{₁}−zⱼ_{₂}+λᵢⱼ_{₁}−λᵢⱼ_{₂}+φᵢⱼ_{₁}−φᵢⱼ_{₂}+σᵢεᵢⱼ_{₁}ⱼ_{₂} (8)

As above, the agricultural computer system 116 is configured to train the model 700 with a given training set of data from the growing spaces 102-106.

In this example, the training data set generally includes data from field growing spaces 106 (which may, optionally, be filtered or not), thereby including split planting data indicative of direct relative performance of specific candidate seeds. In addition, the training data set includes data from the research growing spaces 102 and development growing spaces 104. In particular, in this example implementation, the data from the research growing spaces 102 and development growing spaces 104 is pre-processed to represent split data. For example, for a given growing space, the agricultural computer system 116 is configured to designate one of the seeds included in the data as a control seed. The control seed may include, for example, without limitation, the highest populated seeds in the growing space. The agricultural computer system 116 is programmed, or configured, to then generate a yield delta for the field between the control seed and each of the seeds included in the field. The data, then, is expressed as yield deltas between the seeds in the field, as defined by acreage, location, etc. It should be appreciated that the data may be pre-processed in other manners to conform to the split plant data form, and may further be exposed to correction associated with the data from the research growing spaces 102 and development growing spaces 104 (e.g., γ from model 400, etc.). It should further be appreciated that data from the research growing spaces 102 and development growing spaces 104 may be included in other models (e.g., model 300, etc.) in this or other manners.

From the training data set, the terms of model 700 are determined, for numerous samples, through the Bayesian framework. As a result of the training, a data structure of values is generated by the agricultural computer system 116, which includes numerous different samples. Each of the samples, as explained in more detail below, will include values satisfying the above equations and the constraints applied thereto. The data structure of values for the samples, from the Bayesian framework, define for this implementation the model 700 of the yield deltas for the candidate seeds.

While the specific implementations for training models are illustrated above, it should be appreciated that other implementations are within the scope of the present disclosure. In general, the yield data between a target seed and a candidate seed is based on a yield advantage, and the difference between the yield advantages of the seeds may be adjusted or corrected for various factors, such as, for example, noise, location, etc. Equation (9), below, represents a further expression of the yield deltas between two seeds that may be implemented in the present disclosure.

dᵢⱼ_{₁}ⱼ_{₂}=zⱼ_{₁}−zⱼ_{₂}+xᵢ′(eⱼ_{₁}−eⱼ_{₂})+σᵢεᵢⱼ_{₁}ⱼ_{₂} (9)

The above expression may further be adapted to account for additional data, such as, for example, customer or field insights, environment effects, soil conditions, or other real, evident or apparent disparities between the seeds being compared, as included in the different growing spaces (e.g., spaces 102-104, etc.).

Regardless of the particular data relied on, and the particular model implemented, the agricultural computer system 116 is programmed, or configured, to utilize the Bayesian framework, or other suitable modeling technique, based on the training data set, to define the given model. The model may include any suitable number of samples, or solutions, and may be subject to any suitable distributions, constraints, etc. That is, for each of the implementations above, the respective model is trained, by the agricultural computer system 116, based on the training data set. The model, in various embodiments, is then represented as a data structure, including each of the samples and/or solutions for the training data set and the specific model.

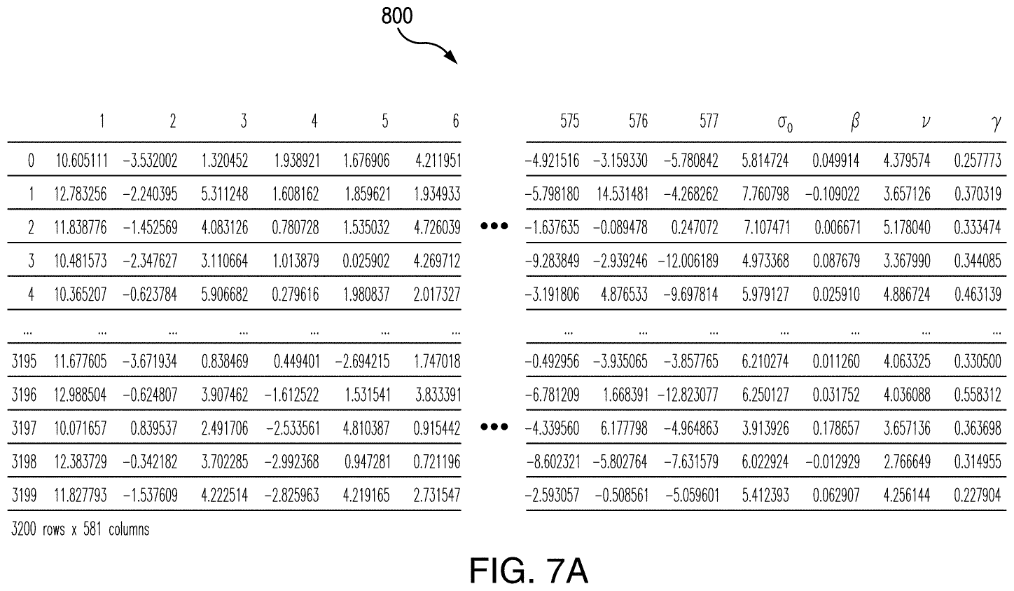

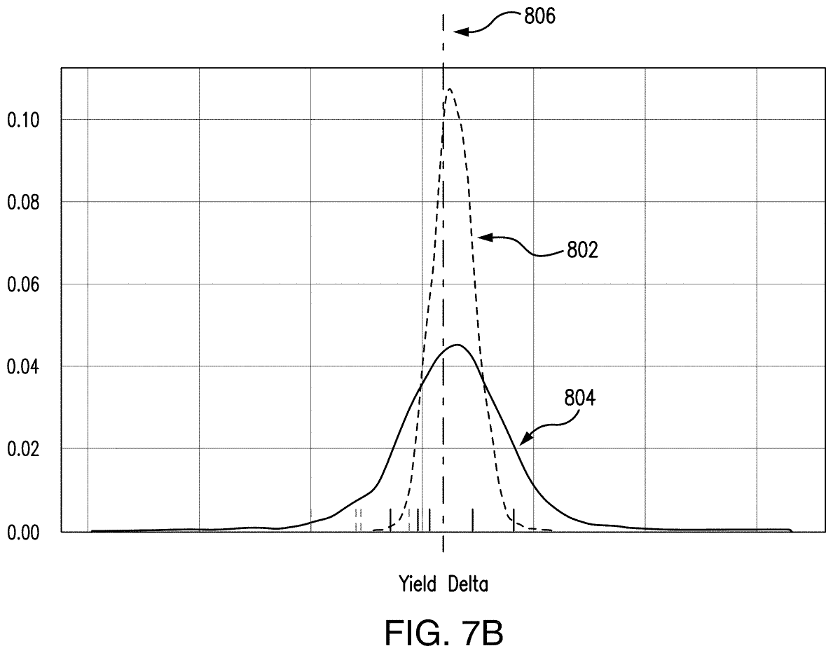

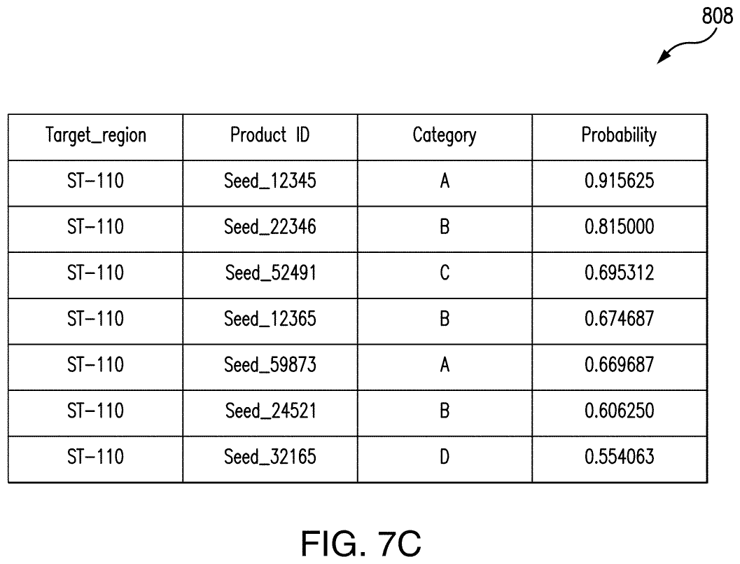

FIG. 7A illustrates an example data structure 800 for model 400, as an example. The data structure 800 includes three thousand two hundred samples (3200), and corresponding values, from the Bayesian framework. It should be appreciated that a different number of samples may be included in other system embodiments. In this example, the columns represent a yield advantage zⱼ for each candidate seed (i.e., five hundred seventy-seven (577) candidate seeds) (although a different number of seeds may be included in a different training data set), and then also parameters of the model 400. As shown, values are included for γ, ν, σ₀, and β from Equations (1), (3), (6) and (7) above. The data structure 800 is then used, as the model, to determine yield deltas for the specific target seed relative to each of the included candidate seeds. For example, at row zero (i.e., one sample), if seed 4 is the target seed, and seed 5 is the candidate seed, a predicted yield delta would be determined as follows, for example, where 40 represents the acreage of the trial, and −0.312000 is a random variate generated from a t-distribution with parameter v=4.379574:

d_{0,4,5}=1.938921−1.676906+(5.814724×40^{0.049914}×−0.312000)=−1.191895

The predicted yield delta may be determined, by the agricultural computer system 116, in this same manner (using Equation (1) in this example) for each of the samples. The collection of predicted yield deltas characterize the distribution of potential observed yield deltas for S×S of these two products in a trial with 40 acres. FIG. 7B provides a graphical representation of the data included in the data structure 800 for a target seed and one candidate seed. As shown, the plot 802 illustrates the differences of the yield advantages of the target seed and the candidate seed (i.e., z_{target}−z_{candidate}) And, the plot 804 illustrates the yield deltas, when the noise term (σ₀xεᵢ) from Equation (1) is included with the differences of the yield advantages. In addition, each of the yield deltas for the training data set including the two seeds is also included. As shown, the plots 802, 804 are presented in terms of yield delta versus distribution of the respective yield deltas (e.g., whereby area under the plot is 1).

It should be appreciated that, while FIG. 7B illustrates one manner of representing the data included in the model, as generated by the agricultural computer system 116, other manners of representing, processing, compiling, or using the model may be employed in other embodiments.

After the model is trained, and represented as desired, or not, for each combination of target seed and candidate seed, the agricultural computer system 116 is configured to then identify one of the candidate seeds as recommended for the target field and/or the target seed. In particular, in this example embodiment, the agricultural computer system 116 is configured to define a performance threshold for candidate seeds, which may be based on the data, input by a user/grower, or otherwise defined. The threshold may include a specified or defined yield delta improvement of about 0.1 bushels/acre or more, about 0.5 bushels/acre or more, about 1 bushels/acre or more, about 2 bushels/acre or more, about 3 bushels/acre or more, about 4 bushels/acre or more, about 5 bushels/acre or more, about 10 bushels/acre or more, about 15 bushels/acre or more, about 20 bushels/acre or more, etc., of the candidate seed over the target seed. When the threshold is applied to the different yield deltas, expressed as probabilities, the probability of a candidate seed providing a performance of greater than the specified threshold is determined.

As shown in FIG. 7B, because the x-axis represents yield delta, the threshold appears as a vertical line along the x-axis (as referenced 806). Thus, the probability of the candidate seed of FIG. 7B exceeding the target seed by the threshold 806 is the area under the plot 804 and to the right of the threshold 806. The agricultural computer system 116 is configured to determine the probability for each candidate seed included in the data structure 800 in a similar manner, whereby each candidate seed is associated with a probability of performing as defined by the threshold.

The agricultural computer system 116 may then be programmed, or configured, optionally, to reduce the set of candidates seeds (e.g., by filtering, selection, etc.), based on the parameters of the specific candidate seeds. For example, the agricultural computer system 116 may be configured to eliminate candidate seeds that do not have the same feature set as the target seed (e.g., relative maturity, insect resistance, disease resistance, drought tolerance, pesticide tolerance, nutrient content, plant height, plant type, cost, etc.). For example, when the target seed is maize, with traits to protect against both above and below ground insects, the agricultural computer system 116 may be configured to filter out candidate seeds inconsistent with the plant type and with the traits of the target seed.

In connection with identifying ones of the candidates seeds, the agricultural computer system 116 is programmed, or configured, in this embodiment, to impose a probability threshold for the candidate seeds. Specifically, for example, the agricultural computer system 116 may be configured to impose a probability threshold of about 50%, about 60%, about 75%, about 80%, or other suitable threshold for the candidates seeds, whereby candidates seeds that fail to satisfy the probability threshold are eliminated from the set of candidate seeds.

Additionally, or alternatively, in identifying the candidate seeds, the agricultural computer system 116 may also be configured to limit the set of candidate seeds based on a category of the candidate seeds (e.g., within a given pipeline, etc.). The category (or status or availability or maturity, etc.) of the candidate seeds, as explained above, may indicate a timing of the candidate seeds in their progression in a given pipeline (e.g., a breeding pipeline, a commercial pipeline, etc.), for example, from introduction (e.g., where the seed is first available for sale, where the seed is first available for use in a breeding program, etc.) up to removal (e.g., when the seed is no longer offered for sale, no longer available for use in a breeding program, etc.). By imposing a limit, the agricultural computer system 116 may ensure that a variety of candidates, availabilities, statuses, etc. of seeds are included in the set of candidate seeds recommended to the grower, and potentially, that candidate seeds having one or more particular categories, availabilities, statuses, etc. are not recommended (e.g., seeds that have been removed from a pipeline, seeds that are not yet available in a pipeline, etc.). A set of candidate seeds with a variety of categories, availabilities, statuses, etc. provides more flexibility in accommodating growers different preferences for trying newer seed products.

FIG. 7C illustrates an example listing 808 of candidate seeds, which have been identified as recommended in view of a specific target field and/or target seeds. As shown, the listing 808 includes the candidate seeds in order of probability, from highest to lowest. In this example, the agricultural computer system 116 imposes a probability threshold of 55%, whereby each of the candidate seeds in the listing 808 has a greater than 55% probability of the candidate seed outperforming the target seed by a desired performance threshold. As further shown, the listing 808 also includes candidate seeds in different categories (e.g., different categories of a commercial pipeline such as introduction (e.g., category A, etc.), currently present (e.g., category B, category C, etc.), removal (e.g., category D, etc.), etc.). It should be appreciated that the listing may be otherwise, in other embodiments, and/or may include more or less information about the candidate seeds in other embodiments.

Referring again to FIG. 1, in this example embodiment, the agricultural computer system 116 is also programmed, or configured, to output a set of candidate seeds as recommended for the target seed and/or the target field. The set of candidate seeds may be provided in a table, similar to the listing 808 in FIG. 7C, in which the probabilities are included. Alternatively, the set of candidate seeds may be included only as a listing of names and other suitable information, but with the probabilities removed and/or obscured. The set of candidate seeds may be output to the grower, or other user, via email, in a user interface at a website or web-based application, or otherwise, etc. In at least one embodiment, the set of candidate seeds is preserved at a user interface along with the option to purchase one or more of the candidate seeds in the set.

One (or more) seed(s) from the set of candidate seeds is then selected, by the grower/user. This may include the grower/user ordering and/or purchasing the selected candidate seeds, for instance, via the agricultural computer system 116, etc. (e.g., whereby the agricultural computer system 116 receives the order, purchase request, etc. from the grower/user, in response to output of the candidate seeds to the grower/user and a corresponding selection by the grower/user; etc.), and then the agricultural computer system 116 directing the selected seeds to the grower/user (e.g., delivering the selected seeds to the target field, etc.). In addition, the selected one of the set of candidate seeds is planted, by the grower/user or other party, in the target field along with the target seed, thereby forming a split planting arrangement to permit the seeds to grow and be harvested. In doing so, broadly, the selected candidate seeds are included (e.g., planted, etc.) in the target field, based on the selection described above (e.g., with the target seeds, etc.). This may include the grower/user receiving the selected candidate seeds and operating a planter to plant the seeds. Alternatively, this may include the agricultural computer system 116 generating planting instructions (e.g., scripts, etc.) based on the selected candidate seeds and providing the instructions to a planter whereby the planter operates, in response to the instructions, to plant the selected candidate seeds in the target field (e.g., upon delivery of the selected seeds to the planter, etc.). In this manner, the grower is able to test the recommendation, and the seed seller associated with the agricultural computer system 116 (and/or the agricultural computer system 116 itself) is programmed or able to make recommendations of seeds to be included in the growing spaces 106, in a split planting scheme with a target seed, while having confidence that the recommended seeds will outperform the target seed.

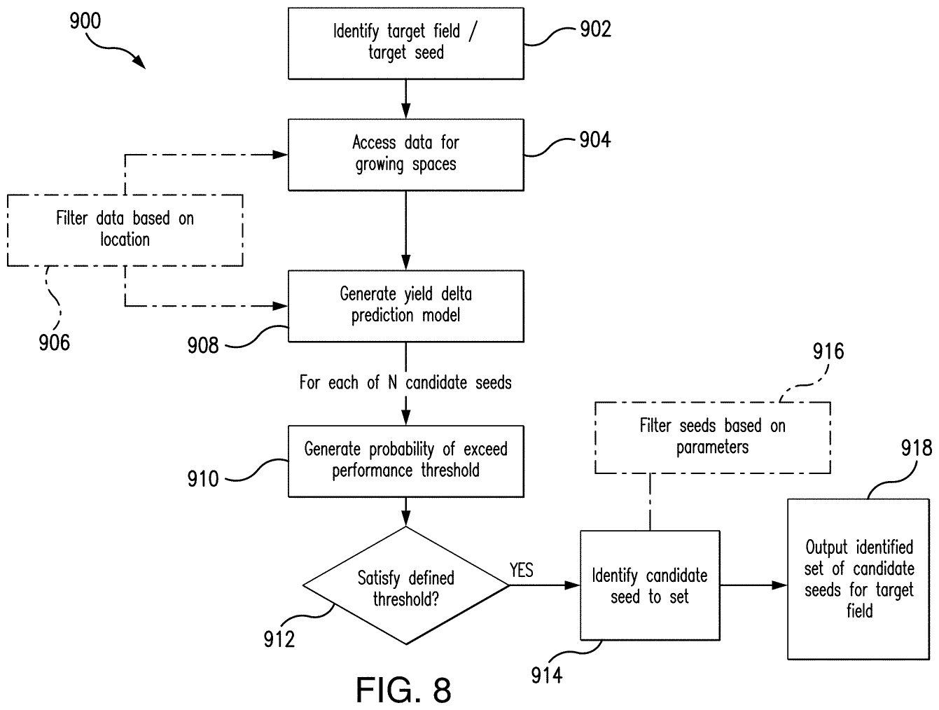

FIG. 8 illustrates an example method 900 for identifying a set of candidate seeds for a target field based on a prediction model. The example method 900 is described herein in connection with the system 100, and may be implemented, in whole or in part, in the agricultural computer system 116 of the system 100. However, it should be appreciated that the method 900, or other methods described herein, are not limited to the system 100 or the agricultural computer system 116. And, conversely, the systems, data structures, and the computing devices described herein are not limited to the example method 900.

At the outset, in method 900, a user identifies, at 902, a target seed and/or a target field, as part of a request to identify a recommended one or more candidate seed(s) for the target seed in the target field. The target seed is identified based on a seed identifier, and may further be accompanied with a listing of trait(s) and/or a description of the target seed (e.g., a type of plant associated therewith, traits, etc.). The target field is identified based on a location (e.g., longitude/latitude, etc.) (or an area defined by location) of a growing space including the target field. The target field may also be identified by soil type and other features or parameters of the growing space, etc. In addition, the request may also include a performance threshold, or not. When included, the performance threshold may indicate a margin at which a recommended candidate seed would outperform the target seed, as expressed in bushels per acre, or otherwise. Again, the user may include a farmer, an individual selling or otherwise marketing or promoting the candidate seeds for planting or other use, etc.

At 904, the agricultural computer system 116 accesses data from the data servers 114a-b. The agricultural computer system 116 may be configured to access the data, as needed, or used in the particular model. For example, the agricultural computer system 116 may access data for research, development and field growing spaces 102-106, together or separately. The data may include, for example, without limitation, for each seed, a seed identifier, a yield, harvested area, a type of data designation, a field identifier, a growing season, a seed type and/or description, a field location, a field type, a description, and/or one or more growing condition(s), etc.

Further, the access of the data may be limited to a particular region, in general, or specific to the different types of data. For example, for the field growing spaces 106, only split planting data for a specific region relative to or defined by the target field's location may be accessed. Similarly, for the research growing spaces 102 and the development growing spaces 104, only data within a defined region may be accessed by the agricultural computer system 116. Moreover, the data accessed, by the agricultural computer system 116, may be limited to the data relevant to the specific target seed (e.g., data for like or comparable seeds, etc.).

Alternatively, as shown in FIG. 8, the agricultural computer system 116 may access data and then, optionally (as indicated by the dotted lines), filter, at 906, the data based on one or more of the criteria above. For example, the accessed data may be filtered by the agricultural computer system 116 based on a location of the target field, or a type of the target seed, etc. It should be appropriate that the model is based on the data, which is either accessed specifically or filtered, and will be relevant to and usable for requests specific to the data. For example, when the data is accessed or specific to a RM band, and specific to maize, the resulting model (as explained below) will be useable for different requests for fields located in the RM band and for maize.

It should be appreciated that in several embodiments, the agricultural computer system 116 may access all relevant data, and omit filtering of the data, whereby the model is based on the accessed data and may be used in connection with further requests associated with multiple target seeds and/or target locations. It should further be appreciated that data related to a known seed, which is similar to a candidate seed, may be employed for the candidate seed, when data associated with the candidate seed specifically is unknown. The data may be specific to a seed identified, which is identified as similar based on features, characteristics, and/or performance of the seed (e.g., predicted yield, seed type, region suitability, etc.).

At least a portion of the accessed and/or filter data is defined as a training data set. At 908, the agricultural computer system 116 generates a yield delta prediction model based on the training data set. The agricultural computer system 116, in this example embodiment, employs the Bayesian framework and a yield delta model expression as described herein, to generate the model specific to the candidate seeds included in the training data set. The model may include hundreds or thousands of samples, or more or less, etc. It should also be appreciated that other modeling techniques may be used in other embodiments, such as, for example, structural causal modeling and deep neural networks.

In this example embodiment, the model includes a data structure, which includes each of the samples from the modeling, and the relative values of the yield delta model expression for the various candidate seeds included in the training data set.

At 910, for each of the N candidate seeds, the agricultural computer system 116 generates a probability of the specific candidate seed included in the training data set satisfying a performance threshold. In this example embodiment, the performance threshold may be about 1 bushels/acre or more, about 2 bushels/acre or more, about 5 bushels/acre or more, about 10 bushels/acre or more, etc. In at least one embodiment, the performance threshold may be zero, whereby the probability indicates that the candidate seed will simply outperform the target seed with no margin. It should be appreciated that the generated probabilities, per candidate seed, are derived from the model and based on the distribution of yield deltas between the candidate seed, individually, and the target seed.

Once the probabilities are generated, the agricultural computer system 116 determines, at 912, whether the probability for each candidate seed satisfies a defined probability threshold. The defined probability threshold is a threshold applied to the probability, such as, for example, about 50%, about 60%, about 75%, about 90%, or more or less. In this manner, the agricultural computer system 116 determines which seeds have a greater than 75%, for example, probability of exceeding the performance of the target seed by the specified performance threshold.

At 914, the agricultural computer system 116 identifies one or more of the candidate seeds to a set of candidate seeds to recommend to the user (e.g., grower, etc.) for the target field. Consequently, the set of candidate seeds is predicted to outperform the target seed in the target field. The agricultural computer system 116 may optionally apply one or more other filters, at 916, to the set of candidate seeds (as indicated by the dotted lines in FIG. 8). That is, identifying the set of candidate seeds may include filtering the seeds based on one or more parameters, such as, for example, category of seeds, seed type and/or description, number of seeds in the set, etc. In this manner, for example, the agricultural computer system 116 may limit the set of candidate seeds to five, ten or fifteen seeds, or more or less seeds, for example, and may also ensure a diversity of different categories (e.g., only X seed in a given category, where X is a integer (e.g., 2, 3, 4, 8, 15, etc.), etc.).

Then, at 918, the agricultural computer system 116 outputs the identified set of candidate seeds for the target field to the user associated with the agricultural computer system 116. For example, the agricultural computer system 116 may output the set of candidate seeds to a sales representative associated with the grower and/or the target field, etc. The output may include an email, or presentation as part of an interface (e.g., a website, a web application, etc.). Next, the user or grower may then coordinate planting one of the set of candidate seeds, along with the target seed, in the target field for a next growing season.

In turn, one (or more) seed(s) from the set of candidate seeds may be selected by the grower/user. For instance, the grower/use may order and/or purchase the selected candidate seeds, via the agricultural computer system 116, etc. (e.g., whereby the agricultural computer system 116 receives the order, purchase request, etc. from the grower/user, in response to the output of the candidate seeds to the grower/user and a corresponding selection by the grower/user; etc.), and then the agricultural computer system 116 may direct the selected seeds to the grower/user (e.g., deliver the selected seeds to the target field, etc.). In addition, the selected one of the set of candidate seeds may be planted, by the grower/user or other party, in the target field along with the target seed, thereby forming a split planting arrangement to permit the seeds to grow and be harvested. In doing so, broadly, the selected candidate seeds are included (e.g., planted, etc.) in the target field, based on the selection described above. This may include the grower/user receiving the selected candidate seeds and operating a planter to plant the seeds in the target field. Alternatively, this may include the agricultural computer system 116 generating planting instructions based on the selected candidate seeds and providing the instructions to a planter whereby the planter automatically operates, in response to the instructions, to plant the selected candidate seeds in the target field (e.g., upon delivery of the seeds to the planter, etc.).

With reference again to FIG. 1, a user 1002 (e.g., a grower, a sales representative, another user, etc.) in the system 100 may own, operate or possess a field manager computing device 1004 in a field location, or associated with a field location, such as a field 1005 intended for agricultural activities or a management location for one or more agricultural fields. The field manager computing device 1004 is programmed, or configured, to provide field data to the agricultural computer system 116 via one or more networks (as indicated by arrowed lines in FIG. 1) (e.g., for use in identifying characteristics of target field 1005, etc.). Again, the network(s) may each include, without limitation, one or more of a local area networks (LANs), wide area network (WANs) (e.g., the Internet, etc.), mobile/cellular networks, virtual networks, and/or another suitable public and/or private networks capable of supporting communication among parts of the system 100 illustrated in FIG. 1, or any combination thereof.

Examples of field data may include, for example, (a) identification data (for example, acreage, field name, field identifiers, geographic identifiers, boundary identifiers, crop identifiers, and any other suitable data that may be used to identify farm land, such as a common land unit (CLU), lot and block number, a parcel number, geographic coordinates and boundaries, Farm Serial Number (FSN), farm number, tract number, field number, section, township, and/or range), (b) harvest data (for example, crop type, crop variety, crop rotation, whether the crop is grown organically, harvest date, Actual Production History (APH), expected yield, yield, crop price, crop revenue, grain moisture, tillage practice, and previous growing season information), (c) soil data (for example, type, composition, pH, organic matter (OM), cation exchange capacity (CEC)), (d) planting data (for example, planting date, seed(s) type, relative maturity (RM) of planted seed(s), seed population), (e) fertilizer data (for example, nutrient type (Nitrogen, Phosphorous, Potassium), application type, application date, amount, source, method), (f) chemical application data (for example, pesticide, herbicide, fungicide, other substance or mixture of substances intended for use as a plant regulator, defoliant, or desiccant, application date, amount, source, method), (g) irrigation data (for example, application date, amount, source, method), (h) weather data (for example, precipitation, rainfall rate, predicted rainfall, water runoff rate region, temperature, wind, forecast, pressure, visibility, clouds, heat index, dew point, humidity, snow depth, air quality, sunrise, sunset), (i) imagery data (for example, imagery and light spectrum information from an agricultural apparatus sensor, camera, computer, smartphone, tablet, unmanned aerial vehicle, planes or satellite), (j) scouting observations (photos, videos, free form notes, voice recordings, voice transcriptions, weather conditions (temperature, precipitation (current and over time), soil moisture, crop growth stage, wind velocity, relative humidity, dew point, black layer)), (k) soil, seed, crop phenology, pest and disease reporting, and predictions sources and databases, and (l) other data described herein, etc.

As described, data servers 114a, 114b are communicatively coupled to the agricultural computer system 116 and are programmed, or configured, to send external data (e.g., data associated with growing spaces 102-106, etc.) to agricultural computer system 116 via the network(s) herein (e.g., for use in identifying candidate seeds for the target field 1005 identified by the user 1002, etc.). The data servers 114a, 114b may be owned or operated by the same legal person or entity as the agricultural computer system 116, or by a different person or entity, such as a government agency, non-governmental organization (NGO), and/or a private data service provider. Examples of external data include weather data, imagery data, soil data, seed data and seed selection data as described herein, data from the various growing spaces 102-106 herein, or statistical data relating to crop yields, among others. External data may include the same type of information as field data. In some embodiments, the external data may also be provided by data servers 114a, 114b owned by the same entity that owns and/or operates the agricultural computer system 116. For example, the agricultural computer system 116 may include a data server focused exclusively on a type of data that might otherwise be obtained from third party sources, such as weather data. In some embodiments, data servers 114a, 114b may actually be incorporated within the system 116.

The system 100 also includes, as described above, harvesting devices 112a-b configured to harvest seeds from one or more growing spaces (e.g., from field growing space 106, etc.). In some examples, the harvesting devices 112a-b may have one or more remote sensors fixed thereon, where the sensor(s) are communicatively coupled, either directly or indirectly, via the harvesting devices 112a-b to the agricultural computer system 116 and are programmed, or configured, to send sensor data to agricultural computer system 116.

Additional examples of agricultural apparatus that may be included in the system 100 include tractors, combines, other harvesters, planters, trucks, fertilizer equipment, aerial vehicles including unmanned aerial vehicles, and any other item of physical machinery or hardware, typically mobile machinery, and which may be used in tasks associated with agriculture and/or related to operations described herein. In some embodiments, a single unit of the agricultural apparatus may comprise a plurality of sensors that are coupled locally in a network on the apparatus. Controller area network (CAN) is an example of such a network that can be installed in combines, harvesters, sprayers, and cultivators. In connection therewith, then, an application controller associated with the apparatus may be communicatively coupled to agricultural computer system 116 via the network(s) and programmed, or configured, to receive one or more scripts that are used to control an operating parameter of the agricultural apparatus (or another agricultural vehicle or implement) from the agricultural computer system 116 (e.g., planting instructions generated by the agricultural computer system 116 and transmitted to a planter agricultural apparatus that then control operation of the planter agricultural apparatus to plant certain selected seeds (e.g., in a particular manner, etc.), etc.). For instance, a controller area network (CAN) bus interface may be used to enable communications from the agricultural computer system 116 to the agricultural apparatus 112a and/or 112b, for example, such as how the CLIMATE FIELDVIEW DRIVE, available from The Climate Corporation, San Francisco, Calif., is used. Sensor data may consist of the same type of information as field data. In some embodiments, remote sensors may not be fixed to an agricultural apparatus but may be remotely located in the field and may communicate with one or more networks of the system 100.

As indicated above, the network(s) of the system 100 are generally illustrated in FIG. 1 by arrowed lines. In connection therewith, the network(s) broadly represent any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. For instance, the harvesting devices 112a-b in the system 100, data servers 114a, 114b, agricultural computer system 116, and other elements of the system 100 may each comprise an interface compatible with the network(s) and programmed, or configured, to use standardized protocols for communication across the networks, such as TCP/IP, Bluetooth, CAN protocol and higher-layer protocols, such as HTTP, TLS, and the like.

Agricultural computer system 116 is programmed, or configured, to receive field data from field manager computing device 1004, external data from data servers 114a, 114b, and sensor data from one or more remote sensors in the system 100. Agricultural computer system 116 may be further configured to host, use or execute one or more computer programs, other software elements, digitally programmed logic, such as FPGAs or ASICs, or any combination thereof to perform translation and storage of data values, construction of digital models of one or more crops on one or more fields, generation of recommendations and notifications, and generation and sending of scripts, in the manner described further in other sections of this disclosure.

In an embodiment, agricultural computer system 116 is programmed with or comprises a communication layer 1032, a presentation layer 1034, a data management layer 1040, a hardware/virtualization layer 1050, and a model and field data repository 1060. “Layer,” in this context, refers to any combination of electronic digital interface circuits, microcontrollers, firmware, such as drivers, and/or computer programs, or other software elements.

Communication layer 1032 may be programmed, or configured, to perform input/output interfacing functions including sending requests to field manager computing device 1004, data servers 114a, 114b, and remote sensor(s) for field data, external data, and sensor data respectively. Communication layer 1032 may be programmed, or configured, to send the received data to model and field data repository 1060 to be stored as field data (e.g., in computer system 116, etc.).

Presentation layer 1034 may be programmed, or configured, to generate a graphical user interface (GUI) to be displayed on field manager computing device 1004 (e.g., for use in interacting with agricultural computer system to identify the target field 1005, target seed, etc.) or other computers that are coupled to the system 116 through the network(s). The GUI may comprise controls for inputting data to be sent to agricultural computer system 116, generating requests for models and/or recommendations, and/or displaying recommendations, notifications, models, and other field data.

Data management layer 1040 may be programmed, or configured, to manage read operations and write operations involving the repository layer 1060 and other functional elements of the system, including queries and result sets communicated between the functional elements of the system and the repository. Examples of data management layer 1040 include JDBC, SQL server interface code, and/or HADOOP interface code, among others. Repository layer 1060 may comprise a database. As used herein, the term “database” may refer to either a body of data, a relational database management system (RDBMS), or to both. As used herein, a database may comprise any collection of data including hierarchical databases, relational databases, flat file databases, object-relational databases, object oriented databases, distributed databases, and any other structured collection of records or data that is stored in a computer system. Examples of RDBMS's include, but are not limited to including, ORACLE®, MYSQL, IBM® DB2, MICROSOFT® SQL SERVER, SYBASE®, and POSTGRESQL databases. However, any database may be used that enables the systems and methods described herein.

When field data is not provided directly to the agricultural computer system 116 via one or more agricultural machines or agricultural machine devices that interact with the agricultural computer system 116, the user 1002 may be prompted via one or more user interfaces on the device 1004 (served by the agricultural computer system 116) to input such information for use in effecting the selections herein. In an example embodiment, the user 1002 may specify identification data by accessing a map on the device 1004 (served by the agricultural computer system 116) and selecting specific CLUs that have been graphically shown on the map. In an alternative embodiment, the user 1002 may specify identification data by accessing a map on the device 1004 (served by the agricultural computer system 116) and drawing boundaries of the field over the map. Such CLU selection, or map drawings, represent geographic identifiers. In alternative embodiments, the user 1002 may specify identification data by accessing field identification data (provided as shape files or in a similar format) from the U.S. Department of Agriculture Farm Service Agency, or other source, via the device 1004 and providing such field identification data to the agricultural computer system 116.

In an example embodiment, the agricultural computer system 116 is programmed to generate and cause displaying of a graphical user interface comprising a data manager for data input. After one or more fields have been identified using the methods described above, the data manager may provide one or more graphical user interface widgets which when selected can identify changes to the field, soil, crops, tillage, or nutrient practices, and/or which may provide comparison data related to target seed identified by the user 1002 and candidate seeds identified by the disclosure herein for the target field 1005. The data manager may include a timeline view, a spreadsheet view, a graphical view, and/or one or more editable programs.

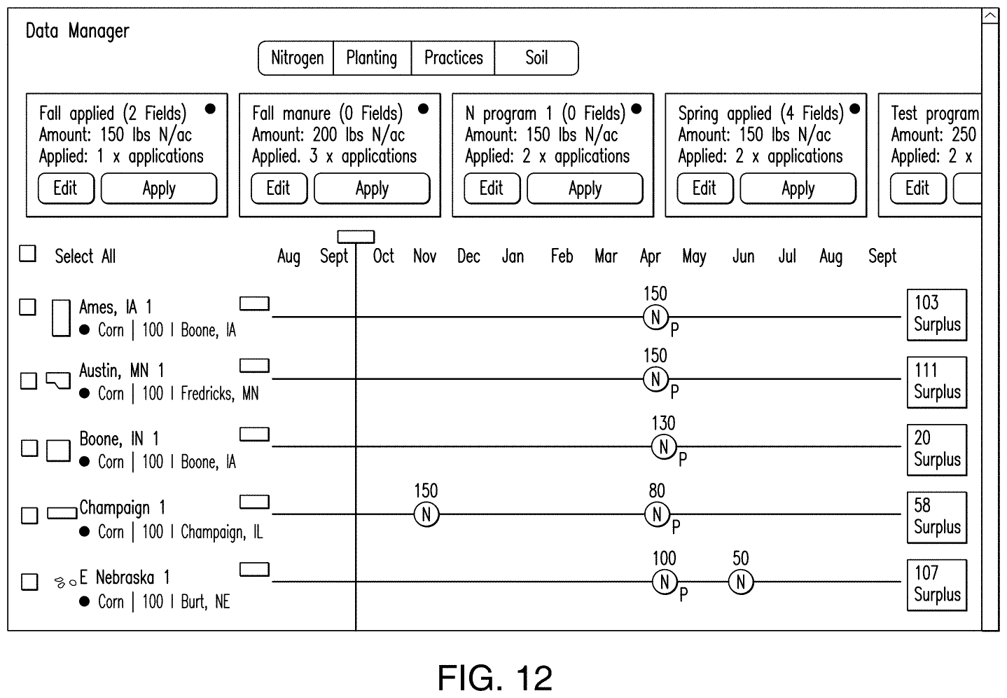

FIG. 12 depicts an example embodiment of a timeline view for data entry. Using the display depicted in FIG. 12, a user computer can input a selection of a particular field and a particular date for the addition of events. Events depicted at the top of the timeline may include Nitrogen, Planting, Practices, and Soil. To add a nitrogen application event, a user computer may provide input to select the nitrogen tab. The user computer may then select a location on the timeline for a particular field in order to indicate an application of nitrogen on the selected field. In response to receiving a selection of a location on the timeline for a particular field, the data manager may display a data entry overlay, allowing the user computer to input data pertaining to nitrogen applications, planting procedures, soil application, tillage procedures, irrigation practices, or other information relating to the particular field. For example, if a user computer selects a portion of the timeline and indicates an application of nitrogen, then the data entry overlay may include fields for inputting an amount of nitrogen applied, a date of application, a type of fertilizer used, and any other information related to the application of nitrogen.

In an embodiment, the data manager provides an interface for creating one or more programs. “Program,” in this context, refers to a set of data pertaining to nitrogen applications, planting procedures, soil application, tillage procedures, irrigation practices, or other information that may be related to one or more fields, and that can be stored in digital data storage for reuse as a set in other operations. After a program has been created, it may be conceptually applied to one or more fields and references to the program may be stored in digital storage in association with data identifying the fields. Thus, instead of manually entering identical data relating to the same nitrogen applications for multiple different fields, a user computer may create a program that indicates a particular application of nitrogen and then apply the program to multiple different fields. For example, in the timeline view of FIG. 12, the top two timelines have the “Spring applied” program selected, which includes an application of 150 lbs N/ac in early April. The data manager may provide an interface for editing a program. In an embodiment, when a particular program is edited, each field that has selected the particular program is edited. For example, in FIG. 12, if the “Spring applied” program is edited to reduce the application of nitrogen to 116 lbs N/ac, the top two fields may be updated with a reduced application of nitrogen based on the edited program.

In an embodiment, in response to receiving edits to a field that has a program selected, the data manager removes the correspondence of the field to the selected program. For example, if a nitrogen application is added to the top field in FIG. 12, the interface may update to indicate that the “Spring applied” program is no longer being applied to the top field. While the nitrogen application in early April may remain, updates to the “Spring applied” program would not alter the April application of nitrogen.

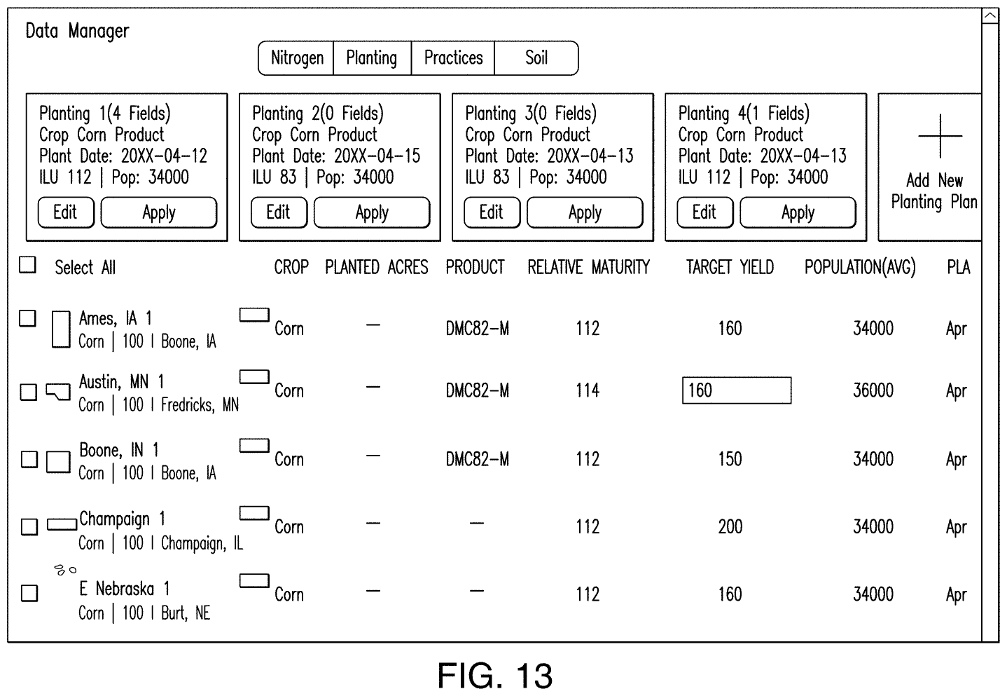

FIG. 13 depicts an example embodiment of a spreadsheet view for data entry. Using the display depicted in FIG. 13, a user can create and edit information for one or more fields. The data manager may include spreadsheets for inputting information with respect to Nitrogen, Planting, Practices, and Soil as depicted in FIG. 13. To edit a particular entry, a user computer may select the particular entry in the spreadsheet and update the values. For example, FIG. 13 depicts an in-progress update to a target yield value for the second field. Additionally, a user computer may select one or more fields in order to apply one or more programs. In response to receiving a selection of a program for a particular field, the data manager may automatically complete the entries for the particular field based on the selected program. As with the timeline view, the data manager may update the entries for each field associated with a particular program in response to receiving an update to the program. Additionally, the data manager may remove the correspondence of the selected program to the field in response to receiving an edit to one of the entries for the field.

In an embodiment, model and field data is stored in model and field data repository layer 1060. Model data comprises data models created for one or more fields. For example, a crop model may include a digitally constructed model of the development of a crop on the one or more fields. “Model,” in this context, refers to an electronic digitally stored set of executable instructions and data values, associated with one another, which are capable of receiving and responding to a programmatic or other digital call, invocation, or request for resolution based upon specified input values, to yield one or more stored or calculated output values that can serve as the basis of computer-implemented recommendations, output data displays, or machine control, among other things. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer. The model may include a model of past events on the one or more fields, a model of the current status of the one or more fields, and/or a model of predicted events on the one or more fields. Model and field data may be stored in data structures in memory, rows in a database table, in flat files or spreadsheets, or other forms of stored digital data.

With reference again to FIG. 1, in an embodiment, instructions 1035 of the agricultural computer system 116 may comprise a set of one or more pages of main memory, such as RAM, in the agricultural computer system 116 into which executable instructions have been loaded and which when executed cause the agricultural computer system 116 to perform the functions or operations that are described herein. For example, the instructions 1035 may comprise a set of pages in RAM that contain instructions which, when executed, cause performing the seed identification functions described herein. The instructions may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. The term “pages” is intended to refer broadly to any region within main memory and the specific terminology used in a system may vary depending on the memory architecture or processor architecture. In another embodiment, the instructions 1035 also may represent one or more files or projects of source code that are digitally stored in a mass storage device, such as non-volatile RAM or disk storage, in the agricultural computer system 116 or a separate repository system, which when compiled or interpreted cause generating executable instructions which when executed cause the agricultural computer system 116 to perform the functions or operations that are described herein. In other words, the drawing figure may represent the manner in which programmers or software developers organize and arrange source code for later compilation into an executable, or interpretation into bytecode or the equivalent, for execution by the agricultural computer system 116.

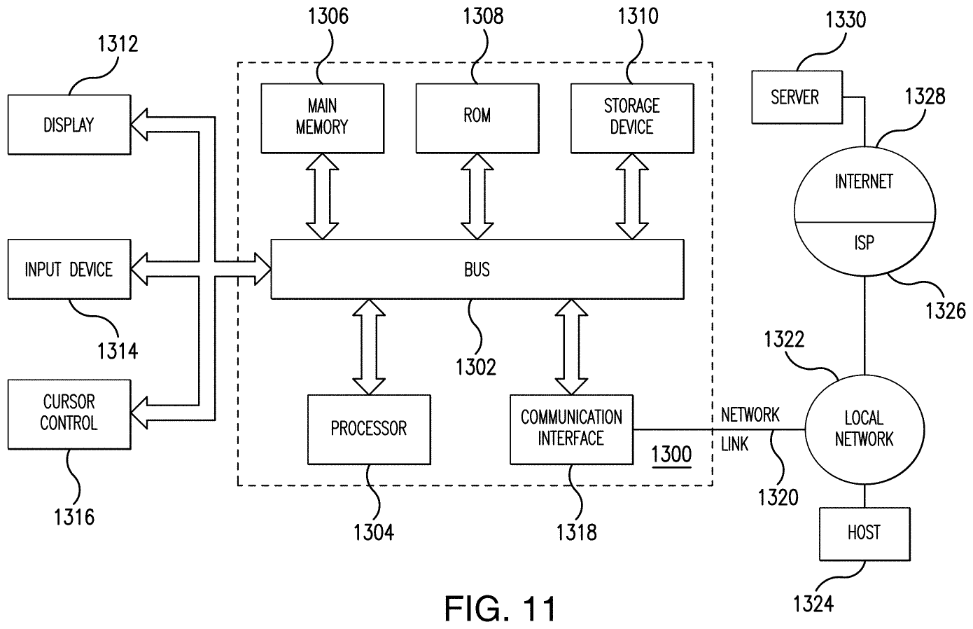

Hardware/virtualization layer 1050 comprises one or more central processing units (CPUs), memory controllers, and other devices, components, or elements of a computer system, such as volatile or non-volatile memory, non-volatile storage, such as disk, and I/O devices or interfaces as illustrated and described, for example, in connection with FIG. 11. The layer 1050 also may comprise programmed instructions that are configured to support virtualization, containerization, or other technologies.

For purposes of illustrating a clear example, FIG. 1 shows a limited number of instances of certain functional elements. However, in other embodiments, there may be any number of such elements. For example, embodiments may use thousands or millions of different mobile computing devices 1004 associated with different users. Further, the system 116 and/or data servers 114a, 114b may be implemented using two or more processors, cores, clusters, or instances of physical machines or virtual machines, configured in a discrete location or co-located with other elements in a datacenter, shared computing facility or cloud computing facility.

In an embodiment, the implementation of the functions described herein using one or more computer programs or other software elements that are loaded into and executed using one or more general-purpose computers will cause the general-purpose computers to be configured as a particular machine or as a computer that is specially adapted to perform the functions described herein. Further, each of the flow diagrams that are described further herein may serve, alone or in combination with the descriptions of processes and functions in prose herein, as algorithms, plans or directions that may be used to program a computer or logic to implement the functions that are described. In other words, all the prose text herein, and all the drawing figures, together are intended to provide disclosure of algorithms, plans or directions that are sufficient to permit a skilled person to program a computer to perform the functions that are described herein, in combination with the skill and knowledge of such a person given the level of skill that is appropriate for disclosures of this type.

In an embodiment, user 1002 interacts with agricultural computer system 116 using field manager computing device 1004 configured with an operating system and one or more application programs or apps; the field manager computing device 1004 also may interoperate with the agricultural computer system 116 independently and automatically under program control or logical control and direct user interaction is not always required. Field manager computing device 1004 broadly represents one or more of a smart phone, PDA, tablet computing device, laptop computer, desktop computer, workstation, or any other computing device capable of transmitting and receiving information and performing the functions described herein. Field manager computing device 1004 may communicate via a network using a mobile application stored on field manager computing device 1004, and in some embodiments, the device may be coupled using a cable or connector to one or more sensors and/or other apparatus in the system 100. A particular user 1002 may own, operate or possess and use, in connection with system 100, more than one field manager computing device 1004 at a time.

The mobile application associated with the field manager computing device 1004 may provide client-side functionality, via the network to one or more mobile computing devices. In an example embodiment, field manager computing device 1004 may access the mobile application via a web browser or a local client application or app. Field manager computing device 1004 may transmit data to, and receive data from, one or more front-end servers, using web-based protocols, or formats, such as HTTP, XML and/or JSON, or app-specific protocols. In an example embodiment, the data may take the form of requests and user information input, such as field data, into the mobile computing device. In some embodiments, the mobile application interacts with location tracking hardware and software on field manager computing device 1004 which determines the location of field manager computing device 1004 using standard tracking techniques, such as multilateration of radio signals, the global positioning system (GPS), WiFi positioning systems, or other methods of mobile positioning. In some cases, location data or other data associated with the device 1004, user 1002, and/or user account(s) may be obtained by queries to an operating system of the device or by requesting an app on the device to obtain data from the operating system.

In an embodiment, in addition to other functionalities described herein, field manager computing device 1004 sends field data to agricultural computer system 116 comprising or including, but not limited to, data values representing one or more of: a geographical location of the one or more fields, tillage information for the one or more fields, crops planted in the one or more fields, and soil data extracted from the one or more fields. Field manager computing device 1004 may send field data in response to user input from user 1002 specifying the data values for the one or more fields. Additionally, field manager computing device 1004 may automatically send field data when one or more of the data values becomes available to field manager computing device 1004. For example, field manager computing device 1004 may be communicatively coupled to a remote sensor in the system 100, and in response to an input received at the sensor, field manager computing device 1004 may send field data to agricultural computer system 116 representative of the input. Field data identified in this disclosure may be input and communicated using electronic digital data that is communicated between computing devices using parameterized URLs over HTTP, or another suitable communication or messaging protocol. In that sense, in some aspects of the present disclosure, the field data provided by the field manager computing device 1004 may also be stored as external data (e.g., where the field data is collected as part of harvesting crops from growing spaces 102-106, etc.), for example, in data servers 114a, 114b.

A commercial example of the mobile application is CLIMATE FIELDVIEW, commercially available from The Climate Corporation, San Francisco, Calif. The CLIMATE FIELDVIEW application, or other applications, may be modified, extended, or adapted to include features, functions, and programming that have not been disclosed earlier than the filing date of this disclosure. In one embodiment, the mobile application comprises an integrated software platform that allows a grower to make fact-based decisions for their operation because it combines historical data about the grower's fields with any other data that the grower wishes to compare. The combinations and comparisons may be performed in real time and are based upon scientific models that provide potential scenarios to permit the grower to make better, more informed decisions.

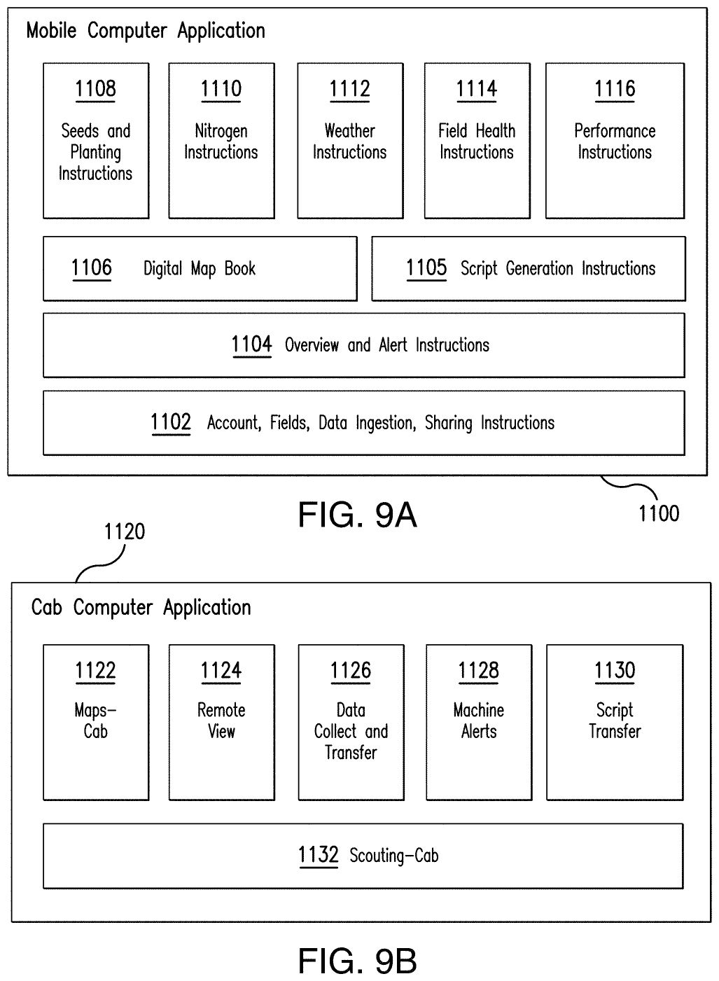

FIGS. 9A-9B illustrate two views of an example logical organization of sets of instructions in main memory when an example mobile application is loaded for execution. Each named element represents a region of one or more pages of RAM or other main memory, or one or more blocks of disk storage or other non-volatile storage, and the programmed instructions within those regions. In one embodiment, in FIG. 9A, a mobile computer application 1100 comprises account-fields-data ingestion-sharing instructions 1102, overview and alert instructions 1104, digital map book instructions 1106, seeds and planting instructions 1108, nitrogen instructions 1110, weather instructions 1112, field health instructions 1114, and performance instructions 1116.

In one embodiment, a mobile computer application 1100 comprises account, fields, data ingestion, sharing instructions 1102 which are programmed to receive, translate, and ingest field data from third party systems via manual upload or APIs. Data types may include field boundaries, yield maps, as-planted maps, soil test results, as-applied maps, and/or management zones, among others. Data formats may include shape files, native data formats of third parties, and/or farm management information system (FMIS) exports, among others. Receiving data may occur via manual upload, e-mail with attachment, external APIs that push data to the mobile application, or instructions that call APIs of external systems to pull data into the mobile application. In one embodiment, mobile computer application 1100 comprises a data inbox. In response to receiving a selection of the data inbox, the mobile computer application 1100 may display a graphical user interface for manually uploading data files and importing uploaded files to a data manager.

In one embodiment, digital map book instructions 1106 comprise field map data layers stored in device memory and are programmed with data visualization tools and geospatial field notes. This provides growers with convenient information close at hand for reference, logging and visual insights into field performance. In one embodiment, overview and alert instructions 1104 are programmed to provide an operation-wide view of what is important to the grower, and timely recommendations to take action or focus on particular issues. This permits the grower to focus time on what needs attention, to save time and preserve yield throughout the season. In one embodiment, seeds and planting instructions 1108 are programmed to provide tools for seed selection, hybrid placement, and script creation, including variable rate (VR) script creation, based upon scientific models and empirical data. This enables growers to maximize yield or return on investment through optimized seed purchase, placement and population.

In one embodiment, script generation instructions 1105 are programmed to provide an interface for generating scripts, including variable rate (VR) fertility scripts. The interface enables growers to create scripts for field implements, such as nutrient applications, planting (e.g., of selected seeds, etc.), and irrigation. For example, a planting script interface may comprise tools for identifying a type of seed for planting. Upon receiving a selection of the seed type, mobile computer application 1100 may display one or more fields broken into management zones, such as the field map data layers created as part of digital map book instructions 1106. In one embodiment, the management zones comprise soil zones along with a panel identifying each soil zone and a soil name, texture, drainage for each zone, or other field data. Mobile computer application 1100 may also display tools for editing or creating such, such as graphical tools for drawing management zones, such as soil zones, over a map of one or more fields. Planting procedures may be applied to all management zones or different planting procedures may be applied to different subsets of management zones. When a script is created, mobile computer application 1100 may make the script available for download in a format readable by an application controller, such as an archived or compressed format. Additionally, and/or alternatively, a script may be sent directly to a cab computer (e.g., associated with apparatus 112a and/or 112b, etc.) from mobile computer application 1100 and/or uploaded to one or more data servers and stored for further use.

In one embodiment, nitrogen instructions 1110 are programmed to provide tools to inform nitrogen decisions by visualizing the availability of nitrogen to crops. This enables growers to maximize yield or return on investment through optimized nitrogen application during the season. Example programmed functions include displaying images, such as SSURGO images, to enable drawing of fertilizer application zones and/or images generated from subfield soil data, such as data obtained from sensors, at a high spatial resolution (as fine as millimeters or smaller depending on sensor proximity and resolution); upload of existing grower-defined zones; providing a graph of plant nutrient availability and/or a map to enable tuning application(s) of nitrogen across multiple zones; output of scripts to drive machinery; tools for mass data entry and adjustment; and/or maps for data visualization, among others. “Mass data entry,” in this context, may mean entering data once and then applying the same data to multiple fields and/or zones that have been defined in the system; example data may include nitrogen application data that is the same for many fields and/or zones of the same grower, but such mass data entry applies to the entry of any type of field data into the mobile computer application 1100. For example, nitrogen instructions 1110 may be programmed to accept definitions of nitrogen application and practices programs and to accept user input specifying to apply those programs across multiple fields. “Nitrogen application programs,” in this context, refers to stored, named sets of data that associates: a name, color code or other identifier, one or more dates of application, types of material or product for each of the dates and amounts, method of application or incorporation, such as injected or broadcast, and/or amounts or rates of application for each of the dates, crop or hybrid that is the subject of the application, among others. “Nitrogen practices programs,” in this context, refer to stored, named sets of data that associates: a practices name; a previous crop; a tillage system; a date of primarily tillage; one or more previous tillage systems that were used; one or more indicators of application type, such as manure, that were used. Nitrogen instructions 1110 also may be programmed to generate and cause displaying a nitrogen graph, which indicates projections of plant use of the specified nitrogen and whether a surplus or shortfall is predicted; in some embodiments, different color indicators may signal a magnitude of surplus or magnitude of shortfall. In one embodiment, a nitrogen graph comprises a graphical display in a computer display device comprising a plurality of rows, each row associated with and identifying a field; data specifying what crop is planted in the field, the field size, the field location, and a graphic representation of the field perimeter; in each row, a timeline by month with graphic indicators specifying each nitrogen application and amount at points correlated to month names; and numeric and/or colored indicators of surplus or shortfall, in which color indicates magnitude.

In one embodiment, the nitrogen graph may include one or more user input features, such as dials or slider bars, to dynamically change the nitrogen planting and practices programs so that a user may optimize his nitrogen graph. The user may then use his optimized nitrogen graph and the related nitrogen planting and practices programs to implement one or more scripts, including variable rate (VR) fertility scripts. Nitrogen instructions 1110 also may be programmed to generate and cause displaying a nitrogen map, which indicates projections of plant use of the specified nitrogen and whether a surplus or shortfall is predicted; in some embodiments, different color indicators may signal a magnitude of surplus or magnitude of shortfall. The nitrogen map may display projections of plant use of the specified nitrogen and whether a surplus or shortfall is predicted for different times in the past and the future (such as daily, weekly, monthly or yearly) using numeric and/or colored indicators of surplus or shortfall, in which color indicates magnitude. In one embodiment, the nitrogen map may include one or more user input features, such as dials or slider bars, to dynamically change the nitrogen planting and practices programs so that a user may optimize his nitrogen map, such as to obtain a preferred amount of surplus to shortfall. The user may then use his optimized nitrogen map and the related nitrogen planting and practices programs to implement one or more scripts, including variable rate (VR) fertility scripts. In other embodiments, similar instructions to the nitrogen instructions 1110 could be used for application of other nutrients (such as phosphorus and potassium), application of pesticide, and irrigation programs.

In one embodiment, weather instructions 1112 are programmed to provide field-specific recent weather data and forecasted weather information. This enables growers to save time and have an efficient integrated display with respect to daily operational decisions.

In one embodiment, field health instructions 1114 are programmed to provide timely remote sensing images highlighting in-season crop variation and potential concerns. Example programmed functions include cloud checking, to identify possible clouds or cloud shadows; determining nitrogen indices based on field images; graphical visualization of scouting layers, including, for example, those related to field health, and viewing and/or sharing of scouting notes; and/or downloading satellite images from multiple sources and prioritizing the images for the grower, among others.

In one embodiment, performance instructions 1116 are programmed to provide reports, analysis, and insight tools using on-farm data for evaluation, insights and decisions. This enables the grower to seek improved outcomes for the next year through fact-based conclusions about why return on investment was at prior levels, and insight into yield-limiting factors. The performance instructions 1116 may be programmed to communicate via the network(s) to back-end analytics programs executed at agricultural computer system 116 and/or data servers 114a, 114b and configured to analyze metrics, such as yield, yield differential, hybrid, population, SSURGO zone, soil test properties, or elevation, among others. Programmed reports and analysis may include yield variability analysis, treatment effect estimation, benchmarking of yield and other metrics against other growers based on anonymized data collected from many growers, or data for seeds and planting, among others.

Applications having instructions configured in this way may be implemented for different computing device platforms while retaining the same general user interface appearance. For example, the mobile application may be programmed for execution on tablets, smartphones, or server computers that are accessed using browsers at client computers. Further, the mobile application as configured for tablet computers or smartphones may provide a full app experience or a cab app experience that is suitable for the display and processing capabilities of a cab computer (e.g., associated with apparatus 112a and/or 112b, etc.). For example, referring now to FIG. 9B, in one embodiment a cab computer application 1120 (e.g., as accessible in one of apparatus 112a, 112b, etc.) may comprise maps-cab instructions 1122, remote view instructions 1124, data collect and transfer instructions 1126, machine alerts instructions 1128, script transfer instructions 1130, and scouting-cab instructions 1132. The code base for the instructions of FIG. 9B may be the same as for FIG. 9A and executables implementing the code may be programmed to detect the type of platform on which they are executing and to expose, through a graphical user interface, only those functions that are appropriate to a cab platform or full platform. This approach enables the system to recognize the distinctly different user experience that is appropriate for an in-cab environment and the different technology environment of the cab. The maps-cab instructions 1122 may be programmed to provide map views of fields, farms or regions that are useful in directing machine operation. The remote view instructions 1124 may be programmed to turn on, manage, and provide views of machine activity in real-time or near real-time to other computing devices connected to the computer system 116 via wireless networks, wired connectors or adapters, and the like. The data collect and transfer instructions 1126 may be programmed to turn on, manage, and provide transfer of data collected at sensors and controllers to the computer system 116 via wireless networks, wired connectors or adapters, and the like (e.g., via network(s) in the system 100, etc.). The machine alerts instructions 1128 may be programmed to detect issues with operations of the machine or tools that are associated with the cab and generate operator alerts. The script transfer instructions 1130 may be configured to transfer in scripts of instructions that are configured to direct machine operations (e.g., as generally described herein, etc.) or the collection of data. The scouting-cab instructions 1132 may be programmed to display location-based alerts and information received from the computer system 116 based on the location of the field manager computing device 1004, harvesting devices 112a-b, or sensors in the field 1005 (or in the growing spaces 102-106) and ingest, manage, and provide transfer of location-based scouting observations to the computer system 116 based on the location of the harvesting devices 112a-b or sensors in the field 1005 (or in the growing spaces 102-106, etc.).

In an embodiment, data servers 114a, 114b stores external data, including soil data representing soil composition for the one or more fields and weather data representing temperature and precipitation on the one or more fields. The weather data may include past and present weather data as well as forecasts for future weather data. In an embodiment, data servers 114a, 114b comprises a plurality of servers hosted by different entities. For example, a first server may contain soil composition data while a second server may include weather data. Additionally, soil composition data may be stored in multiple servers. For example, one server may store data representing percentage of sand, silt, and clay in the soil while a second server may store data representing percentage of organic matter (OM) in the soil. Further, in some embodiments, the data servers 114a, 114b, again, may include data associated with the growing spaces 102-106 with regard to available seeds for use in comparisons, etc.

In an embodiment, remote sensors in the system 100 may comprises one or more sensors that are programmed, or configured, to produce one or more observations. Remote sensor may be aerial sensors, such as satellites, vehicle sensors, planting equipment sensors, tillage sensors, fertilizer or insecticide application sensors, harvester sensors, and any other implement capable of receiving data from the one or more fields (e.g., associated with one or more of the growing spaces 102-106, etc.). In an embodiment, harvesting devices 112a-b may include an application controller programmed, or configured, to receive instructions from agricultural computer system 116. The application controller may also be programmed, or configured, to control an operating parameter of the harvesting devices 112a-b. Other embodiments may use any combination of sensors and controllers, of which the following are merely selected examples.

The system 100 may obtain or ingest data under user 1002 control, on a mass basis from a large number of growers who have contributed data to a shared database system. This form of obtaining data may be termed “manual data ingest” as one or more user-controlled computer operations are requested, or triggered, to obtain data for use by the computer system 116. As an example, the CLIMATE FIELDVIEW application, commercially available from The Climate Corporation, San Francisco, Calif., may be operated to export data to computer system 116 for storing in the repository 1060.

For example, seed monitor systems can both control planter apparatus components and obtain planting data, including signals from seed sensors via a signal harness that comprises a CAN backbone and point-to-point connections for registration and/or diagnostics. Seed monitor systems can be programmed, or configured, to display seed spacing, population and other information to the user via a cab computer of the apparatus, or other devices within the system 100. Examples are disclosed in U.S. Pat. No. 8,738,243 and US Pat. Pub. 201050094916, and the present disclosure assumes knowledge of those other patent disclosures.

Likewise, yield monitor systems may contain yield sensors for harvester apparatus that send yield measurement data to a cab computer of the apparatus, or other devices within the system 100. Yield monitor systems may utilize one or more remote sensors to obtain grain moisture measurements in a combine, or other harvester, and transmit these measurements to the user via the cab computer, or other devices within the system 100.

In an embodiment, examples of sensors that may be used with any moving vehicle, or apparatus of the type described elsewhere herein, include kinematic sensors and position sensors. Kinematic sensors may comprise any of speed sensors, such as radar or wheel speed sensors, accelerometers, or gyros. Position sensors may comprise GPS receivers or transceivers, or WiFi-based position or mapping apps that are programmed to determine location based upon nearby WiFi hotspots, among others.

In an embodiment, examples of sensors that may be used with tractors, or other moving vehicles, include engine speed sensors, fuel consumption sensors, area counters or distance counters that interact with GPS or radar signals, PTO (power take-off) speed sensors, tractor hydraulics sensors configured to detect hydraulics parameters, such as pressure or flow, and/or and hydraulic pump speed, wheel speed sensors or wheel slippage sensors. In an embodiment, examples of controllers that may be used with tractors include hydraulic directional controllers, pressure controllers, and/or flow controllers; hydraulic pump speed controllers; speed controllers or governors; hitch position controllers; or wheel position controllers provide automatic steering.

In an embodiment, examples of sensors that may be used with seed planting equipment, such as planters, drills, or air seeders include seed sensors, which may be optical, electromagnetic, or impact sensors; downforce sensors, such as load pins, load cells, pressure sensors; soil property sensors, such as reflectivity sensors, moisture sensors, electrical conductivity sensors, optical residue sensors, or temperature sensors; component operating criteria sensors, such as planting depth sensors, downforce cylinder pressure sensors, seed disc speed sensors, seed drive motor encoders, seed conveyor system speed sensors, or vacuum level sensors; or pesticide application sensors, such as optical or other electromagnetic sensors, or impact sensors. In an embodiment, examples of controllers that may be used with such seed planting equipment include: toolbar fold controllers, such as controllers for valves associated with hydraulic cylinders; downforce controllers, such as controllers for valves associated with pneumatic cylinders, airbags, or hydraulic cylinders, and programmed for applying downforce to individual row units or an entire planter frame; planting depth controllers, such as linear actuators; metering controllers, such as electric seed meter drive motors, hydraulic seed meter drive motors, or swath control clutches; hybrid selection controllers, such as seed meter drive motors, or other actuators programmed for selectively allowing or preventing seed or an air-seed mixture from delivering seed to or from seed meters or central bulk hoppers; metering controllers, such as electric seed meter drive motors, or hydraulic seed meter drive motors; seed conveyor system controllers, such as controllers for a belt seed delivery conveyor motor; marker controllers, such as a controller for a pneumatic or hydraulic actuator; or pesticide application rate controllers, such as metering drive controllers, orifice size or position controllers.

In an embodiment, examples of sensors that may be used with tillage equipment include position sensors for tools, such as shanks or discs; tool position sensors for such tools that are configured to detect depth, gang angle, or lateral spacing; downforce sensors; or draft force sensors. In an embodiment, examples of controllers that may be used with tillage equipment include downforce controllers or tool position controllers, such as controllers configured to control tool depth, gang angle, or lateral spacing.

In an embodiment, examples of sensors that may be used in relation to apparatus for applying fertilizer, insecticide, fungicide and the like, such as on-planter starter fertilizer systems, subsoil fertilizer applicators, or fertilizer sprayers, include: fluid system criteria sensors, such as flow sensors or pressure sensors; sensors indicating which spray head valves or fluid line valves are open; sensors associated with tanks, such as fill level sensors; sectional or system-wide supply line sensors, or row-specific supply line sensors; or kinematic sensors, such as accelerometers disposed on sprayer booms. In an embodiment, examples of controllers that may be used with such apparatus include pump speed controllers; valve controllers that are programmed to control pressure, flow, direction, PWM and the like; or position actuators, such as for boom height, subsoiler depth, or boom position.

In an embodiment, examples of sensors that may be used with harvesters include yield monitors, such as impact plate strain gauges or position sensors, capacitive flow sensors, load sensors, weight sensors, or torque sensors associated with elevators or augers, or optical or other electromagnetic grain height sensors; grain moisture sensors, such as capacitive sensors; grain loss sensors, including impact, optical, or capacitive sensors; header operating criteria sensors, such as header height, header type, deck plate gap, feeder speed, and reel speed sensors; separator operating criteria sensors, such as concave clearance, rotor speed, shoe clearance, or chaffer clearance sensors; auger sensors for position, operation, or speed; or engine speed sensors. In an embodiment, examples of controllers that may be used with harvesters include header operating criteria controllers for elements, such as header height, header type, deck plate gap, feeder speed, or reel speed; separator operating criteria controllers for features such as concave clearance, rotor speed, shoe clearance, or chaffer clearance; or controllers for auger position, operation, or speed.

In an embodiment, examples of sensors that may be used with grain carts include weight sensors, or sensors for auger position, operation, or speed. In an embodiment, examples of controllers that may be used with grain carts include controllers for auger position, operation, or speed.

In an embodiment, examples of sensors and controllers may be installed in unmanned aerial vehicle (UAV) apparatus or “drones.” Such sensors may include cameras with detectors effective for any range of the electromagnetic spectrum including visible light, infrared, ultraviolet, near-infrared (NIR), and the like; accelerometers; altimeters; temperature sensors; humidity sensors; pitot tube sensors or other airspeed or wind velocity sensors; battery life sensors; or radar emitters and reflected radar energy detection apparatus; other electromagnetic radiation emitters and reflected electromagnetic radiation detection apparatus. Such controllers may include guidance or motor control apparatus, control surface controllers, camera controllers, or controllers programmed to turn on, operate, obtain data from, manage and configure any of the foregoing sensors. Examples are disclosed in U.S. patent application Ser. No. 14/831,165 and the present disclosure assumes knowledge of that other patent disclosures.

In an embodiment, sensors and controllers may be affixed to soil sampling and measurement apparatus that is configured, or programmed, to sample soil and perform soil chemistry tests, soil moisture tests, and other tests pertaining to soil. For example, the apparatus disclosed in U.S. Pat. Nos. 8,767,194 and 8,712,148 may be used, and the present disclosure assumes knowledge of those patent disclosures.

In an embodiment, sensors and controllers may comprise weather devices for monitoring weather conditions of fields. For example, the apparatus disclosed in published international application WO2016/176355A1, may be used, and the present disclosure assumes knowledge of that patent disclosure.

In an embodiment, the agricultural computer system 116 is programmed, or configured, to create an agronomic model. In this context, an agronomic model is a data structure in memory of the agricultural computer system 116 that comprises field data, such as identification data and harvest data for one or more fields. The agronomic model may also comprise calculated agronomic properties which describe either conditions which may affect the growth of one or more crops on a field, or properties of the one or more crops, or both. Additionally, an agronomic model may comprise recommendations based on agronomic factors, such as crop recommendations, irrigation recommendations, planting recommendations, fertilizer recommendations, fungicide recommendations, pesticide recommendations, harvesting recommendations and other crop management recommendations. The agronomic factors may also be used to estimate one or more crop related results, such as agronomic yield. The agronomic yield of a crop is an estimate of quantity of the crop that is produced, or in some examples, the revenue or profit obtained from the produced crop.

In an embodiment, the agricultural computer system 116 may use a preconfigured agronomic model to calculate agronomic properties related to currently received location and crop information for one or more fields. The preconfigured agronomic model is based upon previously processed field data, including but not limited to, identification data, harvest data, fertilizer data, and weather data. The preconfigured agronomic model may have been cross validated to ensure accuracy of the model. Cross validation may include comparison to ground truthing that compares predicted results with actual results on a field, such as a comparison of precipitation estimate with a rain gauge or sensor providing weather data at the same or nearby location or an estimate of nitrogen content with a soil sample measurement.

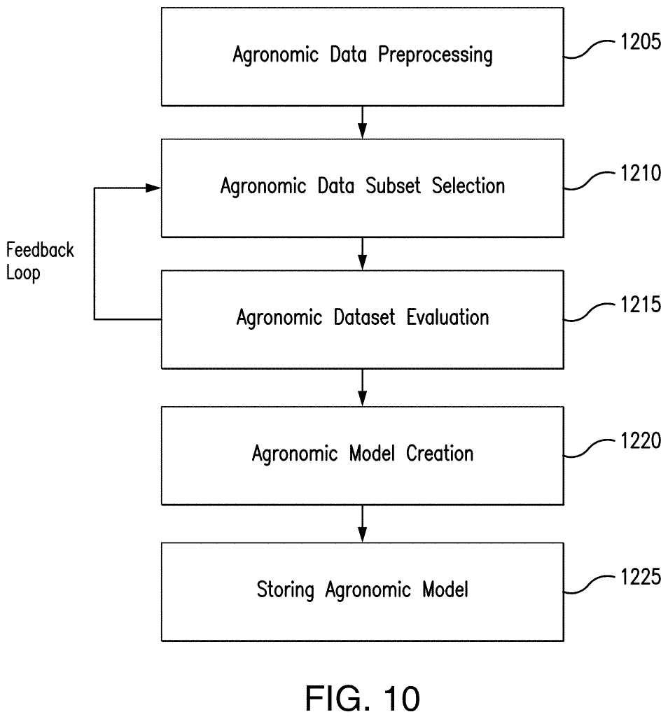

FIG. 10 illustrates a programmed process by which the agricultural computer system 116 generates one or more preconfigured agronomic models using field data provided by one or more data sources. FIG. 10 may serve as an algorithm or instructions for programming the functional elements of the agricultural computer system 116 to perform the operations that are now described.

At block 1205, the agricultural computer system 116 is configured, or programmed, to implement agronomic data preprocessing of field data received from one or more data sources. The field data received from one or more data sources may be preprocessed for the purpose of removing noise, distorting effects, and confounding factors within the agronomic data including measured outliers that could adversely affect received field data values. Embodiments of agronomic data preprocessing may include, but are not limited to, removing data values commonly associated with outlier data values, specific measured data points that are known to unnecessarily skew other data values, data smoothing, aggregation, or sampling techniques used to remove or reduce additive or multiplicative effects from noise, and other filtering or data derivation techniques used to provide clear distinctions between positive and negative data inputs.

At block 1210, the agricultural computer system 116 is configured, or programmed, to perform data subset selection using the preprocessed field data in order to identify datasets useful for initial agronomic model generation. The agricultural computer system 116 may implement data subset selection techniques including, but not limited to, a genetic algorithm method, an all subset models method, a sequential search method, a stepwise regression method, a particle swarm optimization method, and an ant colony optimization method. For example, a genetic algorithm selection technique uses an adaptive heuristic search algorithm, based on evolutionary principles of natural selection and genetics, to determine and evaluate datasets within the preprocessed agronomic data.

At block 1215, the agricultural computer system 116 is configured, or programmed, to implement field dataset evaluation. In an embodiment, a specific field dataset is evaluated by creating an agronomic model and using specific quality thresholds for the created agronomic model. Agronomic models may be compared and/or validated using one or more comparison techniques, such as, but not limited to, root mean square error with leave-one-out cross validation (RMSECV), mean absolute error, and mean percentage error. For example, RMSECV can cross validate agronomic models by comparing predicted agronomic property values created by the agronomic model against historical agronomic property values collected and analyzed. In an embodiment, the agronomic dataset evaluation logic is used as a feedback loop where agronomic datasets that do not meet configured quality thresholds are used during future data subset selection steps (block 1210).

At block 1220, the agricultural computer system 116 is configured, or programmed, to implement agronomic model creation based upon the cross validated agronomic datasets. In an embodiment, agronomic model creation may implement multivariate regression techniques to create preconfigured agronomic data models.

At block 1225, the agricultural computer system 116 is configured, or programmed, to store the preconfigured agronomic data models for future field data evaluation.

According to one embodiment, the techniques described herein are implemented by one or more special-purpose computing devices. The special-purpose computing devices may be hard-wired to perform the techniques, or may include digital electronic devices, such as one or more application-specific integrated circuits (ASICs) or field programmable gate arrays (FPGAs), that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

For example, FIG. 11 is a block diagram that illustrates a computer system 1300 upon which embodiments of the present disclosure may be implemented. Computer system 1300 includes a bus 1302 or other communication mechanism for communicating information, and a hardware processor 1304 coupled with bus 1302 for processing information. Hardware processor 1304 may be, for example, a general purpose microprocessor.

Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Such instructions, when stored in non-transitory storage media accessible to processor 1304, render computer system 1300 into a special-purpose machine that is customized to perform the operations specified in the instructions.

Computer system 1300 further includes a read only memory (ROM) 1308, or other static storage device coupled to bus 1302, for storing static information and instructions for processor 1304. A storage device 1310, such as a magnetic disk, optical disk, or solid-state drive, is provided and coupled to bus 1302 for storing information and instructions.

Computer system 1300 may be coupled via bus 1302 to a display 1312, such as a cathode ray tube (CRT), for displaying information to a computer user. An input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. This input device typically has two degrees of freedom in two axes, a first axis (e.g., x, etc.) and a second axis (e.g., y, etc.), that allows the device to specify positions in a plane.

Computer system 1300 may implement the techniques described herein using customized hard-wired logic, one or more ASICs or FPGAs, firmware and/or program logic which in combination with the computer system causes or programs computer system 1300 to be a special-purpose machine. According to one embodiment, the techniques herein are performed by computer system 1300 in response to processor 1304 executing one or more sequences of one or more instructions contained in main memory 1306. Such instructions may be read into main memory 1306 from another storage medium, such as storage device 1310. Execution of the sequences of instructions contained in main memory 1306 causes processor 1304 to perform the process steps described herein. In alternative embodiments, hard-wired circuitry may be used in place of, or in combination with, software instructions.

The term “storage media” as used herein refers to any non-transitory media that stores data and/or instructions that cause a machine to operate in a specific fashion. Such storage media may comprise non-volatile media and/or volatile media. Non-volatile media includes, for example, optical disks, magnetic disks, or solid-state drives, such as storage device 1310. Volatile media includes dynamic memory, such as main memory 1306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from, but may be used in conjunction with, transmission media. Transmission media participates in transferring information between storage media. For example, transmission media includes coaxial cables, copper wire and fiber optics, including the wires that comprise bus 1302. Transmission media can also take the form of acoustic or light waves, such as those generated during radio-wave and infrared data communications.

Various forms of media may be involved in carrying one or more sequences of one or more instructions to processor 1304 for execution. For example, the instructions may initially be carried on a magnetic disk or solid-state drive of a remote computer. The remote computer can load the instructions into its dynamic memory and send the instructions over a telephone line using a modem. A modem local to computer system 1300 can receive the data on the telephone line and use an infra-red transmitter to convert the data to an infra-red signal. An infra-red detector can receive the data carried in the infrared signal and appropriate circuitry can place the data on bus 1302. Bus 1302 carries the data to main memory 1306, from which processor 1304 retrieves and executes the instructions. The instructions received by main memory 1306 may optionally be stored on storage device 1310 either before or after execution by processor 1304.

Computer system 1300 also includes a communication interface 1318 coupled to bus 1302. Communication interface 1318 provides a two-way data communication coupling to a network link 1320 that is connected to a local network 1322. For example, communication interface 1318 may be an integrated services digital network (ISDN) card, cable modem, satellite modem, or a modem to provide a data communication connection to a corresponding type of telephone line. As another example, communication interface 1318 may be a local area network (LAN) card to provide a data communication connection to a compatible LAN. Wireless links may also be implemented. In any such implementation, communication interface 1318 sends and receives electrical, electromagnetic or optical signals that carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the world wide packet data communication network now commonly referred to as the “Internet” 1328. Local network 1322 and Internet 1328 both use electrical, electromagnetic or optical signals that carry digital data streams. The signals through the various networks and the signals on network link 1320 and through communication interface 1318, which carry the digital data to and from computer system 1300, are example forms of transmission media.

Computer system 1300 can send messages and receive data, including program code, through the network(s), network link 1320 and communication interface 1318. In the Internet example, a server might transmit a requested code for an application program through Internet 1328, ISP 1326, local network 1322 and communication interface 1318.

The received code may be executed by processor 1304 as it is received, and/or stored in storage device 1310, or other non-volatile storage for later execution.

With that said, it should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) accessing data from a data server, the data including data representative of seeds harvested from at least one of a research growing space, a development growing space, and a field growing space; (b) generating a yield delta prediction model, based on at least a portion of the accessed data; (c) for each of a plurality of candidate seeds, automatically generating a probability of a yield delta for the candidate seed, relative to a target seed, exceeding a performance threshold, based on the generated model; (d) identifying a set of the candidate seeds, based on the probability of the respective candidate seed satisfying a defined threshold; (e) outputting the identified set of seeds to a user; and (f) including (e.g., planting, etc.) at least one seed from the identified set of candidate seeds in a target field.

Examples and embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more example embodiments disclosed herein may provide all or none of the above mentioned advantages and improvements and still fall within the scope of the present disclosure.

Specific values disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may also be suitable for the given parameter (i.e., the disclosure of a first value and a second value for a given parameter can be interpreted as disclosing that any value between the first and second values could also be employed for the given parameter). For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, and 3-9.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “in communication with,” or “included with” another element or layer, it may be directly on, engaged, connected or coupled to, or associated or in communication or included with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying a set of candidate seeds for a target field based on a prediction model, the method comprising:
accessing, by a computing device, data from a data server, the data including data representative of seeds harvested from at least one of a research growing space, a development growing space, and a field growing space;
generating a yield delta prediction model, based on at least a portion of the accessed data;
for each of a plurality of candidate seeds, automatically generating a probability of a yield delta for the candidate seed, relative to a target seed, exceeding a performance threshold, based on the generated model;
identifying, by the computing device, a set of the candidate seeds, based on the probability of the respective candidate seed satisfying a defined threshold;
outputting, by the computing device, the identified set of candidate seeds to a user; and
including at least one seed from the identified set of candidate seeds in a target field.

2. The computer-implemented method of claim 1, further comprising:
receiving a request including the target seed and a target field from the user; and
filtering, by the computing device, the accessed data based on a region including the target field, wherein the region includes one of: a relative maturity band and a region of interest.

3. The computer-implemented method of claim 1, wherein the data includes data representative of seeds harvested from the research growing space, the development growing space, and the field growing space; and
wherein the data representative of seeds harvested from the field growing space includes split planting data indicative of: at least two candidate seeds or one candidate seed and the target seed.

4. The computer-implemented method of claim 1, wherein generating the yield delta prediction model includes generating the model based on a Bayesian framework; and/or
wherein generating the model includes generating a plurality of samples for a training data set and a model expression.

5. The computer-implemented method of claim 1, wherein the plurality of candidate seeds includes a first candidate seed and a second candidate seed;
wherein generating the yield delta prediction model is based, at least in part, on:
dᵢⱼ_{₁}ⱼ_{₂}=zⱼ_{₁}−zⱼ_{₂}+σᵢεᵢⱼ_{₁}ⱼ_{₂}; and
wherein dᵢ is the yield delta, zⱼ_{₁} is the first candidate seed, zⱼ_{₂} is the second candidate seed, and σᵢεᵢ is a noise expression.

6. The computer-implemented method of claim 1, wherein generating the model includes generating a plurality of samples for a training data set and a model expression; and
wherein the probability of a yield delta for the candidate seed relative to a target seed exceeding a performance threshold is based on a distribution of the predicted yield deltas for the candidate seed and the target seed included in the samples.

7. The computer-implemented method of claim 6, wherein the performance threshold is between about 1.0 bushels/acre and about 10.0 bushels/acre; and/or
wherein the defined threshold is between about 50% and about 100%; and/or
wherein the samples of the training data set include more than one thousand samples.

8. The computer-implemented method of claim 1, further comprising selecting one or more seed from the identified set of candidate seeds; and
wherein including at least one seed from the identified set of candidate seeds in the target field includes planting the target seed and the selected one or more seed in a field, in a split planting configuration.

9. A non-transitory computer-readable storage medium including executable instructions, which, when executed by at least one processor in connection with identifying a set of candidate seeds for a target field based on a prediction model, cause the at least one processor to perform the following steps:
accessing data from a data server, the data including data representative of seeds harvested from at least one of a research growing space, a development growing space, and a field growing space;
generating a yield delta prediction model, based on at least a portion of the accessed data;
for each of a plurality of candidate seeds, generating a probability of a yield delta for the candidate seed, relative to a target seed, exceeding a performance threshold, based on the generated model;
identifying a set of the candidate seeds, based on the probability of the respective candidate seed satisfying a defined threshold;
outputting the identified set of seeds to a user;
generating planting instructions for an agricultural planting apparatus, based on the identified set of candidate seeds, to plant at least one seed from the identified set of candidate seeds in a target field; and
transmitting the planting instructions to the agricultural planting apparatus, whereby the agricultural planting apparatus operates, in response to the planting instructions, to plant the at least one seed in the target field.

10. A system for use in identifying a set of candidate seeds for a target field based on a prediction model, the system comprising:
at least one data server including data representative of seeds harvested from at least one of a research growing space, a development growing space, and a field growing space; and
at least one computing device in communication with the at least one data server, the at least one computing device configured to:
generate a yield delta prediction model based on at least a portion of the data in the at least one data server;
for each of a plurality of candidate seeds, automatically generate a probability of a yield delta for the candidate seed, relative to a target seed, exceeding a performance threshold, based on the generated model;
identify a set of the candidate seeds based on the probability of the respective candidate seed satisfying a defined threshold;
output the identified set of seeds to a user; and
generate planting instructions for an agricultural planting apparatus, based on the identified set of candidate seeds, to plant at least one seed from the identified set of candidate seeds in a target field, whereby the agricultural planting apparatus operates to plant the at least one seed in the target field in response to the planting instructions.

11. The system of claim 10, wherein the at least one computing device is further configured to:
receive a request including the target seed and a target field from the user; and
filter the accessed data based on a region including the target field, wherein the region includes one of: a relative maturity band and a region of interest.

12. The system of claim 11, wherein the at least one computing device is configured, in order to generate the yield delta prediction model, to generate the yield delta prediction model based on a Bayesian framework.

13. The system of claim 12, wherein the at least one computing device is configured, in order to generate the yield delta prediction model, to generate a plurality of samples for a training data set and a model expression.

14. The system of claim 13, wherein the probability of the yield delta for the candidate seed, relative to the target seed, for each of the plurality of candidate seeds, exceeding the performance threshold is further based on a distribution of the predicted yield deltas for the candidate seed and the target seed included in the samples.

15. The system of claim 14, wherein the performance threshold is between about 1.0 bushels/acre and about 10.0 bushels/acre;
wherein the defined threshold is between about 50% and about 100%; and
wherein the samples of the training data set include more than one thousand samples.

16. The system of claim 10, wherein the plurality of candidate seeds includes a first candidate seed and a second candidate seed;
wherein the at least one computing device is configured, in order to generate the yield delta prediction model, to generate the yield delta prediction model based, at least in part, on:
dᵢⱼ_{₁}ⱼ_{₂}=zⱼ_{₁}−zⱼ_{₂}+σᵢεᵢⱼ_{₁}ⱼ_{₂} and
wherein dᵢ is the yield delta, zⱼ_{₁} is the first candidate seed, zⱼ_{₂} is the second candidate seed, and σᵢεᵢ is a noise expression.

17. The system of claim 10, wherein the data includes data representative of seeds harvested from the research growing space, the development growing space, and the field growing space; and
wherein the data representative of seeds harvested from the field growing space includes split planting data indicative of: at least two candidate seeds or one candidate seed and the target seed.

18. The system of claim 10, further comprising the target field in which the at least one seed from the identified set of candidate seeds output to the user is planted, in a split planting configuration.
